(19) United States
(12) Patent Application Publication
(10) Pub. No.: US 2026/0203082 A1
(43) Pub. Date: Jul. 16, 2026

(54) COMPUTER USING AGENT WITH HYBRID HUMAN AND GENERATIVE RESPONSE ENGINE CONTROL

(71) Applicant: OpenAI OpCo, LLC., San Francisco, CA (US)

(72) Inventor: Yash Kumar, San Francisco, CA (US)

(73) Assignee: OpenAI OpCo, LLC., San Francisco, CA (US)

(21) Appl. No.: 19/021,747

(22) Filed: Jan. 15, 2025

(51) Int. Cl. G06F 9/451; G06F 16/34

(52) U.S. Cl. CPC G06F 9/452; G06F 16/345

(57) ABSTRACT

Disclosed are systems, apparatuses, processes, and computer-readable media for executing a autonomous remote browser based on a generative response engine. For example, a method can be executed at a local device to interact with a remote browser. The present technology includes transmitting, from a local application, an instruction to a remote browser service to spawn a remote browser in a container, wherein the instruction includes a natural language task for the remote browser to perform at a first address. The present technology includes receiving a stream based on execution of the natural language task in the remote browser by a generative response engine. The stream includes images illustrating the remote browser and data describing at least events generated by the generative response engine for the remote browser. The local application can render the images and the data from the stream in the local application.

### BACKGROUND

Generative response engines such as large language models represent a significant milestone in the field of artificial intelligence, revolutionizing computer-based natural language understanding and generation. Generative response engines, powered by advanced deep learning techniques, have demonstrated astonishing capabilities in tasks such as text generation, translation, summarization, and even code generation. Generative response engines can sift through vast amounts of text data, extract context, and provide coherent responses to a wide array of queries.

### BRIEF DESCRIPTION OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings, and the claims.

FIG. 1 illustrates an example system supporting a generative response engine during inference operations in accordance with some embodiments of the present technology;

FIG. 2 is conceptual diagram illustrating a remote application service configured for agent control of a remote application executed in a containerized environment in accordance with some aspects of the disclosure;

FIG. 3 is a sequence diagram illustrating operation of a remote application service 304 using a combination of user control and machine control in accordance with some aspects of the disclosure;

FIG. 4 is a sequence diagram illustrating persistent storage for a remote application service in accordance with some aspects of the disclosure;

FIGS. 5A to 5K illustrate various screenshots of a remote application displayed at a client device in accordance with some aspects of the disclosure;

FIG. 6 is a flow diagram of a process for executing a remote application at a client device in accordance with some aspects of the disclosure;

FIG. 7 is a flow diagram of a process for executing a remote application by an agent in accordance with some aspects of the disclosure;

FIG. 8 is a block diagram illustrating an example machine learning platform for implementing various aspects of this disclosure in accordance with some aspects of the present technology;

FIG. 9A, FIG. 9B, and FIG. 9C illustrates an example transformer architecture in accordance with some embodiments of the present technology; and

FIG. 10 shows an example of computing system that can implement various aspects of the present technology and any engine illustrated in FIG. 1 or any component thereof.

### DESCRIPTION

Generative response engines such as large language models represent a significant milestone in the field of artificial intelligence, revolutionizing computer-based natural language understanding and generation. Generative response engines, powered by advanced deep learning techniques, have demonstrated astonishing capabilities in tasks such as text generation, translation, summarization, and even code generation. However, despite their remarkable linguistic prowess, these generative response engines operate on a foundation of publicly available information and do not possess personal information about individual users.

Many generative response engines provide a conversational user interface powered by a chatbot whereby the user account interacts with the generative response engine through natural language conversation with the chatbot. Such a user interface provides an intuitive format to provide prompts or instructions to the generative response engine. In fact, the conversational user interface powered by the chatbot can be so effective that users can feel as if they are interacting with a person. Some user accounts find the generative response engine effective enough that they utilize the conversational user interface powered by the chatbot as they would an assistant.

In some aspects, a generative response engine is configured to accept multimodal inputs and can be trained to understand visual changes and could potentially implement a computer agent, which is an autonomous software program designed to perform tasks, make decisions, or provide insights on behalf of a user. Computer agents can analyze vast amounts of data, automate repetitive actions, and respond intelligently to specific triggers. For instance, a person might use a computer agent to monitor stock prices and execute trades, schedule and manage appointments, or sift through extensive datasets to find trends or anomalies. Computer agents can act on behalf of a person to perform tasks to save time, enhance efficiency, and reduce the cognitive burden of managing complex or mundane tasks.

However, deploying computer agents can pose privacy concerns, especially when they handle sensitive data such as financial transactions, personal communications, or proprietary business information. Running the agent in a remote environment (e.g., a secure cloud server) can mitigate these risks by centralizing data access within a controlled, monitored, and encrypted system. The remote environment reduces the potential for data breaches on local devices, ensures compliance with security best practices, and balances functionality and privacy. Both user and machine control inputs are important with computer agents to ensure they operate within defined parameters, align with the user instructions, and adapt to dynamic environments or specific requirements.

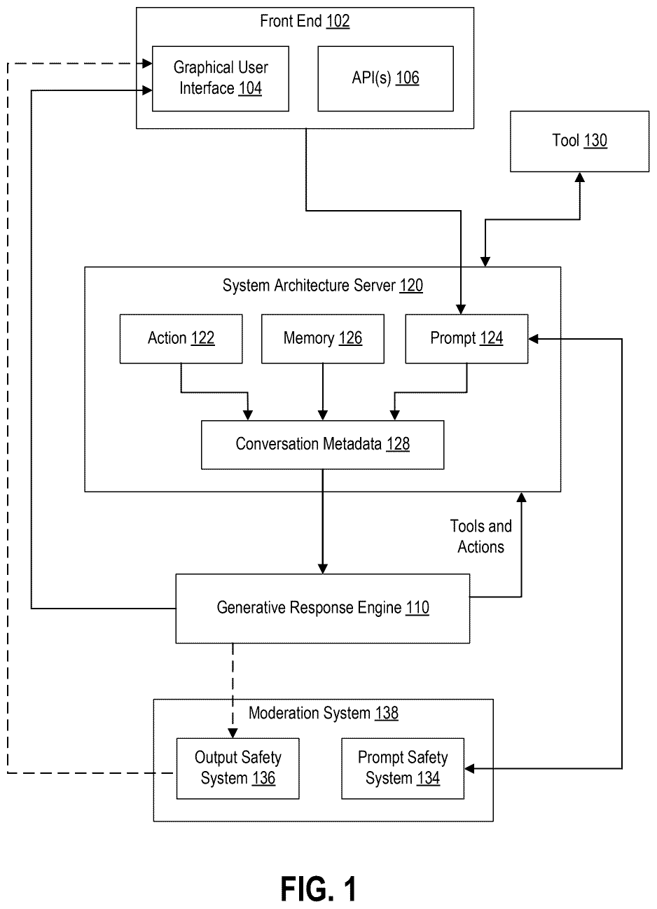

FIG. 1 illustrates an example system supporting a generative response engine during inference operations in accordance with some embodiments of the present technology. Although the example system depicts particular system components and an arrangement of such components, this depiction is to facilitate a discussion of the present technology and should not be considered limiting unless specified in the appended claims. For example, some components that are illustrated as separate can be combined with other components, and some components can be divided into separate components.

The generative response engine 110 is an artificial intelligence (AI) that can generate content in response to a prompt. The prompt can be from a human or a software entity (AI or applications). The prompt is generally in natural language but could be in code, including binary. Some examples of the generative response engine can include language models that generate language, such as CHATGPT, or other models, such as DALL-E, which generates images, and SORA, which generates videos. CHATGPT, DALL-E, and SORA are all provided by OPENAI, but the generative response engine is not limited to AI provided by OPENAI. The generative response engine can also be any type of generative AI and can include AI developed using various architectures such as diffusion models and transformers (e.g., a generative pre-trained transformer) and combinations of models.

In some instances, a language model, such as CHATGPT, can receive prompts to output images, video, code, applications, etc., which it can provide by interfacing with one or more other models, as will be addressed further herein.

Users and applications can interact with the generative response engine 110 through the front end 102. The front end 102 serves as the interface and intermediary between the user and the generative response engine. It encompasses the graphical user interface 104 and Application Programming Interfaces (APIs) 106 that facilitate communication, input processing, and output presentation. Generally, users interact through a graphical user interface 104 that often includes a conversational interface, and applications interact through the API 106, but this is not a requirement.

The graphical user interface 104 is the platform through which users interact with the generative response engine 110. It can be a web-based chat window, a mobile application, or any interface that supports data input and output. The graphical user interface 104 facilitates a conversation between the user and the generative response engine, as the user provides prompts in the graphical user interface 104 to which the generative response engine responds and presents those responses in the graphical user interface 104. In some embodiments, graphical user interface 104 presents a conversational interface, which has attributes of a conversation thread between a user account and generative response engine 110.

The graphical user interface 104 is configured to perform input handling, context management, and output presentation. The type of inputs that can be received can be relative to the specifics of the generative response engine 110. But even when a model doesn't directly accept certain types of inputs, the front end 102 might be able to receive different types of inputs, which can be converted to inputs that are accepted by the generative response engine 110. For example, a language model is generally configured to accept text, but the front end 102 can accept voice and convert it to text or accept an image and create a textual representation.

The graphical user interface 104 is also configured to maintain the context of the conversation, which allows for coherent and relevant responses. For example, the graphical user interface 104 is responsible for providing the conversation thread and other relevant context accessible to the front end 102 to the generative response engine along with the specific prompt to the generative response engine. For example, a conversation between the user account and the generative response engine 110 can have taken several turns (prompt, response, prompt, response, etc.). When the user account provides a further prompt, the graphical user interface 104 can provide that prompt to the generative response engine in the context of the entire conversation.

In another example, the front end 102 might have access to a memory 126 where facts about the user account have been stored. In some embodiments, these facts can have been identified as facts worth storing by the generative response engine and the front end 102 has stored these facts at the direction of the generative response engine. Accordingly, these facts can be provided to the generative response engine 110 along with a user-provided prompt so that the generative response engine has access to these facts when generating a response.

In another example, the graphical user interface 104 might be configured to provide a system prompt along with a user-provided prompt. A system prompt is hidden from the user account and is used to set the behavior and guidelines for the generative response engine. It can be used to define the AI's persona, style, and constraints.

The graphical user interface 104 is also configured to display the responses from the generative response engine, which might include text, code snippets, images, or interactive elements.

In some embodiments, the generative response engine 110 can provide instructions to the front end 102 that instruct the graphical user interface 104 about how to display some of the output from the generative response engine. For example, the generative response engine can direct the graphical user interface 104 to present code in a code-specific format, or to present interactive graphics, or static images. In other examples, the generative response engine can direct the graphical user interface 104 to present an interactive document editor where the graphical user interface 104 can be presented with the document editor so that the user account and the generative response engine can collaborate on the document. In some embodiments, the generative response engine 110 can provide instructions to the front end 102 to record facts in a personalization notepad. Accordingly, the graphical user interface 104 does not always display all of the output of the generative response engine.

As noted above, the front end 102 can also provide one or more application programming interfaces (API(s)) 106. APIs enable developers to integrate the generative response engine's capabilities into external applications and services. They provide programmatic access to the generative response engine, allowing for customized interactions and functionalities.

The APIs 106 can accept structured requests containing prompts, context, and configuration parameters. For example, an API can be used to provide prompts and divide the prompt into system prompts and user prompts. In some embodiments, the APIs 106 can provide specific inputs for which the generative response engine 110 is configured to respond with a specific behavior. For example, an API can be used to specify that it requires an output in a particular format or structured output. For example, in the chat completion API, the API call can specify parameters for the output, such as the max length for the desired output, and specify aspects of the tone of the language used in the response. Some common APIs are for participating in a conversation (Chat Completion API), for providing a single response (Completion API), for converting text into embeddings (Embeddings API), etc. The API can also be used to indicate specific decision boundaries that the generative response engine 110 might be trained to interpret. For example, the moderation API can take advantage of the generative response engine's content moderation decision-making. In the case of the moderation API and others, the API might give access to services other than the generative response engine. For example, the moderation API might be an interface to moderation system 138, addressed below.

Some other common APIs include the Fine-Tuning API, which allows developers to customize models of the generative response engine using their own datasets; the Audio and Speech APIs, which cause the generative response engine to output speech or audio; and the Image Generation API, which causes the generative response engine to output images (which might require utilizing other models).

There can also be APIs that direct the generative response engine to interface with other applications or other generative AI engines. In such cases, the specific application or AI engine might be specified, or the generative response engine might be allowed to choose another application of AI engine to utilize in response to a prompt.

In short, the graphical user interface 104 and the APIs 106 can be used to provide prompts to the generative response engine. Prompts are sometimes differentiated into prompt types. For example, a system prompt can be a hidden prompt that sets the behavior and guidelines for the generative response engine. A user prompt is the explicit input provided by the user, which may include questions, commands, or information.

Sitting in between front end 102 and generative response engine 110 is a system architecture server 120. The function of system architecture server 120 is to manage and organize the flow of data among key subsystems, enabling the generative response engine 110 to generate responses that are contextually relevant, accurate, and enriched with additional information as required.

Action 122 facilitates auxiliary tasks that extend beyond basic text generation. In some embodiments, action 122 can be actions that correspond to an API 106. In some embodiments, action 122 can be agentic actions that the generative response engine 110 decides to take to carry out a user's intent as described in the prompt.

Prompt 124 is the request or command provided by the user account through front end 102. In some embodiments, prompt 124 can be further supplemented by a system prompt and other information that might be included by graphical user interface 104 or API 106. In some embodiments, prompt 124 can even be modified or enhanced by generative response engine 110 as addressed further below. Additionally, as the user account provides prompts and generative response engine 110 provides responses, a conversation thread forms. As the user account provides a new prompt, this is appended to the overall conversation and added to prompt 124. Thus, a user account might think of a first user-provided message as a first prompt and a second user-provided message as a second prompt, and so on, but prompt 124 as perceived by generative response engine 110 can include a thread of user-provided messages and responses from generative response engine 110 in a multi-turn conversation. Generally, prompt 124 will include an entire conversation thread, but in some instances, prompt 124 might need to be shortened if it exceeds a maximum accepted length (generally measured by a number of tokens).

System architecture server 120 can also route prompts and response through moderation system 138, which can be separate or part of system architecture server 120. In some embodiments, prompts are provided to prompt safety system 134 before being provided to generative response engine 110. Prompt safety system 134 is configured to use one or more techniques to evaluate prompts to ensure a prompt is not requesting generative response engine 110 to generate moderated content. In some embodiments, prompt safety system 134 can utilize text pattern matching, classifiers, and/or other AI techniques.

Since prompts can evolve over time through the course of a conversation, consisting of prompts and responses, prompts can be repeatedly evaluated at each turn in the conversation.

Memory 126 can facilitate continuity and personalization in conversations. It allows the system to maintain user-specific context, preferences, or details that may inform future interactions. A memory file can be persisted data from previous interactions or sessions that provide background information to maintain continuity. In some embodiments, memory can be recorded at the instruction of generative response engine 110 when generative response engine 110 identifies a fact or data that it determines should be saved in memory because it might be useful in later conversations or sessions.

Conversation metadata 128 can aggregate data points relevant to the conversation, including user prompt 124, action 122, and memory 126. This consolidated information package serves as the input for generative response engine 110. Conversation metadata 128 can label parts of a prompt as user provided, generative response engine provided, a system prompt, memory 126, data from action 122 or tool 130 (addressed below).

The generative response engine is the core engine that processes inputs (from system architecture server 120) and generates outputs. In some embodiments, the generative response engine is a Generative Pre-trained Transformer (GPT), but it could utilize other architectures.

A core feature of generative response engine 110 is to generate content in response to prompts. When the generative response engine 110 is a GPT, it is configured to receive inputs from front end 102 that provide guidance on a desired output. The generative response engine can analyze the input and identify relevant patterns and associations in the data, and it has learned to generate a sequence of tokens that are predicted as the most likely continuation of the input. The generative response engine 110 generates responses by sampling from the probability distribution of possible tokens, guided by the patterns observed during its training. In some embodiments, the generative response engine 110 can generate multiple possible responses before presenting the final one. The generative response engine 110 can generate multiple responses based on the input, and these responses are variations that the generative response engine 110 considers potentially relevant and coherent.

In some embodiments, the generative response engine 110 can evaluate generated responses based on certain criteria. These criteria can include relevance to the prompt, coherence, fluency, and sometimes adherence to specific guidelines or rules, depending on the application. Based on this evaluation, the generative response engine 110 can select the most appropriate response. This selection is typically the one that scores highest on the set criteria, balancing factors like relevance, informativeness, coherence, and content moderation instructions/training.

In some embodiments, an instruction provided by an API 106, a system prompt, or a decision made by generative response engine 110 can cause the generative response engine 110 to interpret a prompt and re-write it or improve the prompt for a desired purpose. For example, generative response engine 110 can determine to take a prompt to make a picture and enhance the prompt to yield a better picture. In these instances, generative response engine 110 can generate its own prompts, which can be provided to a tool 130 or provided to generative response engine 110 to yield a better output response than the original prompt might have.

The generative response engine 110 can also do more than generate content in response to a prompt. In some embodiments, the generative response engine 110 can utilize decision boundaries to determine the appropriate course of action based on the prompt. In some examples, a decision boundary might be used to cause the generative response engine to recognize that it is being asked to provide a response in a particular format such that it will generate its response constrained by the particular format. In some examples, a decision boundary can cause the model to refuse to generate a responsive output if the decision is that the responsive output would violate a moderation policy. In some examples, the decision boundary might cause the generative response engine to recognize that it needs to interface with another AI model or application to respond to the prompt. For example, when the generative response engine is a language model, it might recognize that it is being asked to output an image, and therefore, it needs to interface with a model that can output images to provide a response to the prompt. In another example, the prompt might request a search of the Internet before responding. The generative response engine can use a decision boundary to recognize that it should conduct a search of the Internet and use the results of that search in responding to the prompt. In another example, the prompt might request that the generative response engine take an agentic action on behalf of the user by interacting with a third-party service (e.g., book a reservation for me at . . . ), and the generative response engine can utilize a decision boundary to recognize that it needs to plan steps to locate the third-party service, contact the third-party service, and interact with the third-party service to complete the task and then report back to the user that the action has been completed.

When generative response engine 110 determines that it should take an agentic action on behalf of the user or it should call a tool to aid in providing a quality response to the user account, the generative response engine 110 might call a tool 130 or cause an action 122 to be performed. As indicated above, tools 130 can include internet browsers, editors such as code editors, other AI tools etc. Actions 122 are actions that the generative response engine 110 can cause to be performed, perhaps using tool 130. As used herein actions 122 should be considered to cover a broad array of actions that generative response engine 110 can perform with or without tools 130. Tools 130 are considered to cover a wide variety of services and software that encompass tools such as a computer operating system such that the generative response engine 110 can control the computer operating system on the user's behalf, to robotic actuators, to search browsers and specific applications.

Additionally, the generative response engine 110 can also generate portions of responses that are not displayed to the user. For example, the generative response engine 110 can direct the front end 102 to provide specific behaviors, such as directions for how to present the response from the generative response engine 110 to the user account. In another example, the generative response engine 110 can provide response portions dictated by an API, where portions of the response to the API might be for the consumption of the calling application but not for presentation to the end user.

In some embodiments, the output of generative response engine can be further analyzed by output safety system 136. While generative response engine 110 can perform some of its own moderation, there can be instances where it is desired to have another service review outputs for compliance with the moderation policy. The use of dashed lines in FIG. 1 differentiates a path using output safety system 136 and not using output safety system 136.

While FIG. 1 shows responses being provided back to front end 102 directly, in some embodiments, the responses might be returned by way of system architecture server 120.

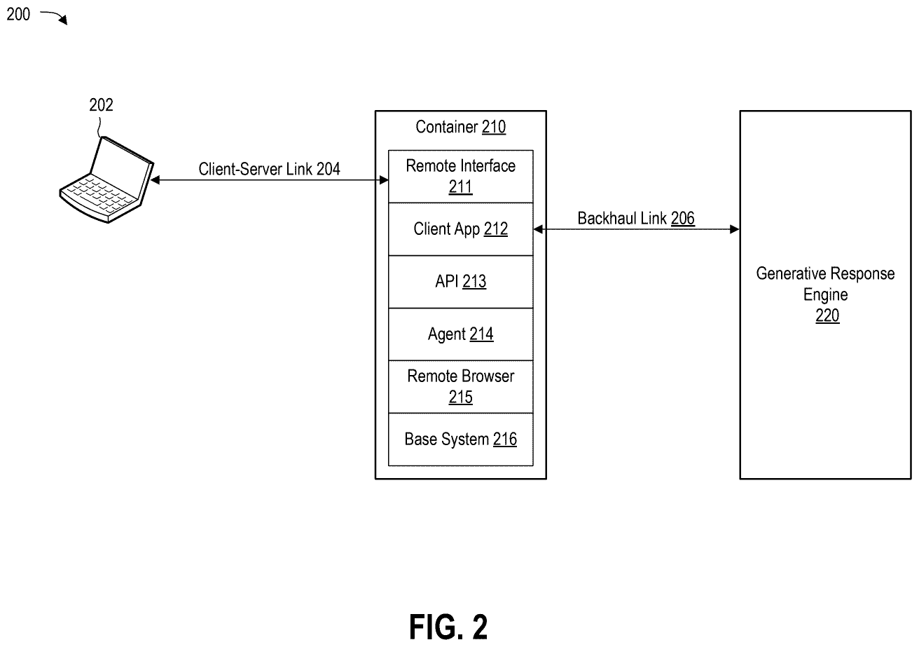

FIG. 2 is a conceptual diagram illustrating a system 200 configured for agent control of a remote application executed in a containerized environment in accordance with some aspects of the disclosure.

In some examples, system 200 includes client device 202 (e.g., a laptop, a mobile phone, etc.) configured to interact with container 210 executing an application in a virtualized environment in connection with generative response engine 220 (e.g., generative response engine 110 of FIG. 1). In some aspects, client device 202 connects to container 210 via client-server link 204 and container 210 connects to client device 202 via backhaul link 206. In some aspects, container 210 and generative response engine 220 execute in various data centers that are geographically dispersed.

Container 210 is a containerized application and includes a stack of different technology components to operate as a remote application on behalf of client device 202. In some aspects, containers, such as those orchestrated by Kubernetes or created using Docker, are lightweight, portable, and isolated virtualized environments that encapsulate software and its dependencies. Containers provide a consistent and reproducible runtime environment and simplify development, testing, and deployment of applications across different platforms and data centers. Containers are important aspects of microservice architectures by allowing applications to be broken into smaller, independently deployable components and are foundational to modern cloud-native development applications.

In some aspects, container 210 includes remote interface 211 that implements an interface for virtualized network computing (VNC). For example, client-server link 204 and remote interface 211 may implement a protocol similar to VNC to allow users of client device 202 to control an application within container 210. There are various types of protocols to implement this behavior such VNC, remote desktop protocol (RDP), X11 forwarding, Citrix independent computing architecture (ICA), and so forth, which can use a persistent network connection such as a web socket or a web transport.

In some cases, container 210 may also store client application 212 that is served to client device 202 and is executed at client device 202. For example, client application 212 may be a JavaScript-bundle to implement various frameworks (e.g., React, etc.) using various rendering techniques such as client-side rendering, server-side rendering, server components, edge rendering, progressive hydration, etc. The JavaScript bundles execute using at least JavaScript within a web browser's sandbox. In other examples, client application 212 may be a webassembly application executed within a browser sandbox. In some cases, client device 202 may also execute a native application that is executed within user space (e.g., has native access to aspects of client device 202).

In some cases, client application 212 can be deployed in conjunction with other applications configurations. For example, in one example, client application 212 may be an extension that is capable of linking an external site with the remote application service. In this case, the extension (e.g., client application 212) may be capable of rendering a modal over a rendered website (e.g., server or client rendered) and allows the user to specify actions for generative response engine 220 to perform within that specific domain. In another example, client application 212 may be a native transparent overlay application that transparently sits over a generic application and enables interaction between the local application and the generative response engine using synthetic input events. In yet other cases, the browser at client device 202 may integrate AI-based functionality and allow several different types of interactions discussed herein.

Container 210 may also include API 213 using a conventional server and middleware components to implement API endpoint, such as the Node. JS engine with Express, Deno, .Net core, and so forth. In some aspects, generative response engine 220 may be configured to interact with container 210 via API 213. API 213 may also be configured to interact with generative response engine 220 via an API on generative response engine 220 (not shown). In some aspects, API 213 can be implemented with REST and HTTP requests. In other cases, other protocols (e.g., a remote procedure call such as gRPC, web sockets, web transport, etc.) can be used over backhaul link 206 to create a stateful connection.

Container 210 may also include agent 214, which provides additional functionality to control remote interface 211 and client application 212. For example, agent 214 can include logic to control access to remote browser 215 (further discussed below) by one of remote interface 211 or API 213. For example, a user and generative response engine 220 trying to control an application, particularly with limited input control options, is unusable. Agent 214 permits only one of remote interface 211 or API 213 to interact with remote browser 215 at discrete times.

In some aspects, container 210 can also include an application for client device 202 and generative response engine 220 to interact with. In some aspects, container 210 includes remote browser 215 that can be interacted with via agent 214 to perform various functions based on client device 202 and generative response engine 220. In some aspects, client device 202 may provide instructions to be performed by remote browser 215 using generative response engine 220. For example, client device 202 may request remote browser 215 to reserve a tennis court. In some aspects, agent 214 is configured to interact with generative response engine 220 and client device 202 to autonomously achieve the user's request.

In some aspects, container 210 may also include base system 216. Base system 216 is configured via the container build instructions, such as by using a base image (e.g., an Alpine Linux build) with instructions to generate the containerized environment. Examples of instructions to generate the containerized environment include installation of packages, insertion of configuration information, performing updates, etc. In some aspects, the container build instructions configure the other components, such as installing remote browser 215, building agent 214, transpiling or compiling client application 212, configuring the server that implements client application 212, etc.

In some aspects, remote browser 215 may be executing in a headless environment (e.g., a container) and agent 214 may be configured to obtain a rendering of remote browser 215. For example, base system 216 can include an endpoint that displays remote browser 215. In some cases, remote browser 215 may be entirely headless and various libraries (e.g., playwright, puppeteer) may obtain a rendering of remote browser 215. In some cases, container 210 can render the image and stream the images to client device 202 and generative response engine 220. That is, even if there is no associated display with container 210, the images may be rendered and sent to external devices and systems and allowing both generative response engine 220 and a user (e.g. using the client device 202) to jointly control the remote browser 215.

In some aspects, generative response engine 220 may be configured to invoke a reasoning model (e.g., the OpenAI o1 model, o3 model, etc.) to iteratively reason to a satisfactory conclusion. It has been found that using a reasoning model with the present technology can improve the performance of the generative response engine 220 in ultimately achieving its task. This is in part due to the fact that a reasoning model first reasons about the steps needed to achieve an outcome. The reasoning model keeps its reasoning as part of the context window as it attempts to achieve a task. In some embodiments, its reasoning is part of an inner monologue from generative response engine 220, addressed further herein. When a step takes longer than anticipated or an error occurs, the reasoning model and further reason about other ways to accomplish the step, or find a way around the step, to get back on track with the ultimate task. For example, as generative response engine 220 received updated images of the current state of the browser, generative response engine 220 can make determinations on how to proceed based on its prior reason and its expected progress through a task. This process occurs iteratively, wherein generative response engine 220 can repeatedly reason about whether it needs to wait for the browser to respond to previous inputs, it needs to try re-entering inputs, it needs to take additional actions, it needs to prompt the user to provide inputs or additional instructions, or it has completed its task.

In some aspects, the generative response engine 220 may also be capable of real-time voice communication, which can make it more effective at receiving and responding to user inputs.

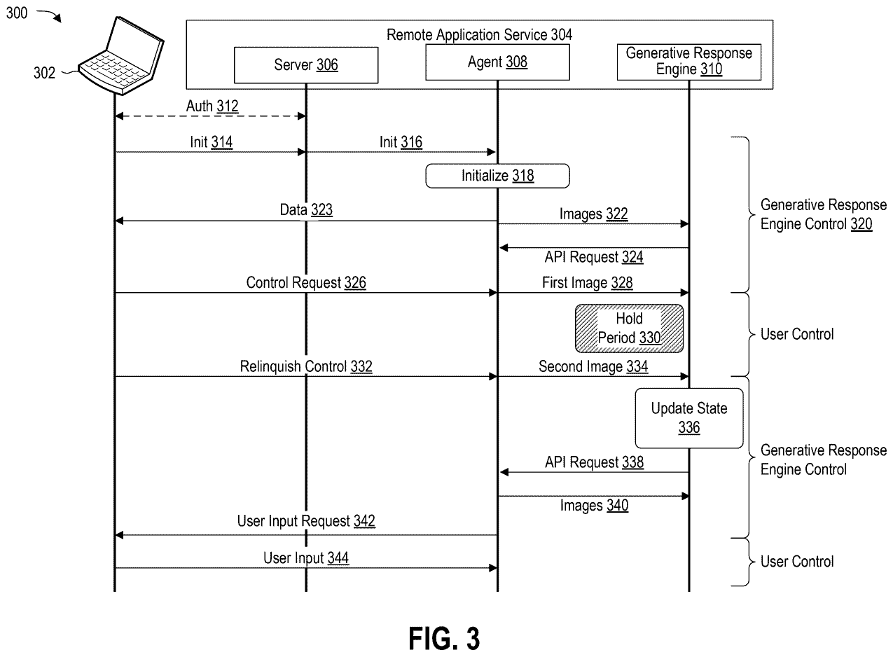

FIG. 3 is a sequence diagram 300 illustrating operation of a remote application service 304 using a combination of user control and machine control in accordance with some aspects of the disclosure. Remote application service 304 includes server 306 for handling initial requests, agent 308 (e.g., executing in a containerized environment such as container 210 in FIG. 2) and generative response engine 310 (e.g., generative response engine 110 of FIG. 1, generative response engine 220 of FIG. 2, etc.) configured to provide synthetic input events into the application. A synthetic input is an input that corresponds to a human input device (e.g., a keyboard, a mouse, etc.) but is input based on a machine control through an API or other corresponding user interface. For example, agent 308 may include an API endpoint to allow a generative response engine to provide synthetic events such as an onClick event handler (e.g., a function) of a button with corresponding parameters. In another example, agent 308 may execute a headless browser that accepts human inputs (e.g., move mouse, click, type, etc.).

In some aspects, client device 302 (e.g., client device 202 of FIG. 2) may optionally first provide authentication credentials 312 to server 306. In this case, server 306 is a front end for the containers used by the system and may activate and deactivate containers. In some aspects, once the user credentials of a person operating client device 302 are authenticated, client device 302 may send an initialization instruction 314 to initiate a remote application. In some aspects, initialization instruction 314 may implicitly indicate the application based on the request. In other aspects, initialization instruction 314 may include explicit information such as an identity of the application. In the described aspects, the application can be a browser (e.g., Chrome, Arc, Safari, etc.). Initialization instruction 314 may also include an initial instruction provided by the user from client device 302. For example, initialization instruction 314 can include a natural language instruction to book a vacation over a holiday to a tropical environment but limit total travel time to ten hours.

In some aspects, in response to initialization instruction 314, server 306 generates initialization instruction 316 and initializes agent 308 (e.g., a container including an agent illustrated in FIG. 2) at block 318. The initialization instruction may include natural language instructions from the user (e.g., from initialization instruction 314 to book a vacation over a holiday). In other cases, the natural language instructions can be provided after the container has booted its virtual environment).

Once agent 308 is initialized, which includes loading a browser within agent 308, agent 308 is controlled by a generative response engine for the duration of generative response engine control. In this case, agent 308, having received the natural language instructions from client device 302, provides a stream of images 322 to generative response engine 310 (e.g., via API request). The stream of data 323 is also provided to client device 302 (e.g., via a VNC interface) including images (e.g., different from stream of images 322) and other types of data. In some aspects, a stream is a sequence of data elements made available over time and typically is used to process or transmit data incrementally as it is produced or received. In this case, although images appear at a discrete time (with time increasing in the downward direction in FIG. 3), the streams (e.g., images 322 and data 323) are presumed to be continually provided to client device 302 and generative response engine 310 unless expressly illustrated or described. The images can be in different forms, such as compressed, comprise optical flow information, etc.). The images provided to client device 302 may also be different from the images provided to generative response engine 310. For example, the images provided to generative response engine 310 may be aperiodic and based on input events, and the images provided to client device 302 can illustrate changes between input events (e.g., to show mouse movements, mouse hover events, etc.).

In some aspects, the stream of data 323 can include additional information, such as synthetic input events and an inner monologue of the generative response engine or a summary of the inner monologue. In some aspects, the inner monologue (or the summary of the inner monologue) of generative response engine 310 is the model's internal thought process as it analyzes data, makes predictions, and learns from its experiences. The inner monologue reflects these uncertainties as the model weighs different possibilities and considers the evidence at hand. Through a process of trial and error (e.g., training), the ML model can refine its understanding and adjust predictions based on feedback from the environment. In this way, the inner monologue of an ML model metaphorically captures its ongoing process of analysis, learning, and decision-making as it interacts with data and refines its predictions over time. The inner monologue can also be used in reasoning to resolve a task based on the context of prior reasoning to identify steps to yield a successful outcome. Inner monologues are discussed in U.S. patent application Ser. No. 18/743,594, which is herein incorporated by reference in its entirety for its teachings.

The resolution of the images can vary, and agent 308 may include a mapping service to map discrete inputs from client device 302 and generative response engine 310 based on the source. For example, agent 308 may provide lower-resolution images to generative response engine 310 to improve inference operation, and generative response engine 310 responds with coordinates based on the lower-resolution image. For example, generative response engine 310 can send an instruction to move +50, −10 pixels and then click. Agent 308 may scale the input based on the resolution of the rendering at agent 308. For example, agent 308 may internally render images at a 2K resolution (1920×1080) and generative response engine 310 may accept images at 800×600 resolution. In some cases, the resolution at agent 308 may also be controlled based on the user input at client device 302. For example, a browser rendering the images from agent 308 may control the image sizes rendered by agent 308 (e.g., by obtaining a viewport size or by obtaining a size using a query selector (e.g., querySelector( ) or querySelectorAll( ) in the document API).

In some aspects, images provided to the generative response engine may be downscaled based on an expected size associated with the generative response engine. For example, the generative response engine may be trained for feature extraction for images having a 512×512 size, and a size of the resolution of a screen associated with the remote browser is arbitrary (e.g., based on viewport size on client device 202).

In some aspects, a full resolution image can also be provided to the generative response engine by segmenting the full resolution image into separate images based on the expected size associated with the generative response engine. The agent may separate current image into individual segments that are suitable for the generative response engine, thereby causing the current screen to be represented as a list of byte arrays. In some cases, the generative response engine may be configured to alternately view the separate images based on the desired view. For example, the generative response engine may want to understand the entire scope and may use the downscaled image. In other cases, generative response engine may need to understand a scope of a region of the remote browser and may only use a single segmented image to view a portion of the current screenshot for fine details.

In some aspects, generative response engine 310 uses the images and the natural language query from client device 302 to perform inputs into agent 308. For example, an initial input from generative response engine 310 may be to navigate to a particular web address (e.g., an airline). In some aspects, generative response engine 310 may provide a synthetic event (e.g., a click) to focus on an address bar of the browser application executing in the container with agent 308) and then type the web address of the airline. As part of the generative response engine control at block 320, agent 308 provides corresponding images to generative response engine 310 and client device 302 illustrating the interactions. In some aspects, agent 308 may also provide additional data to agent 308 such as input events and an inner monologue (or a summary thereof) from generative response engine 310, allowing client device 302 to narrate the events by generative response engine 310.

During block 320, the generative response engine is configured to learn user preferences based on past interaction with similar content. For example, generative response engine can generate information specific to the user's interactions, such as a preference for a particular team for sporting events, seats, preferred times (e.g., for appointments), and so forth. In some aspects, this data can exist in various forms, such as structured content, or may be generated based on natural language input into the generative response engine.

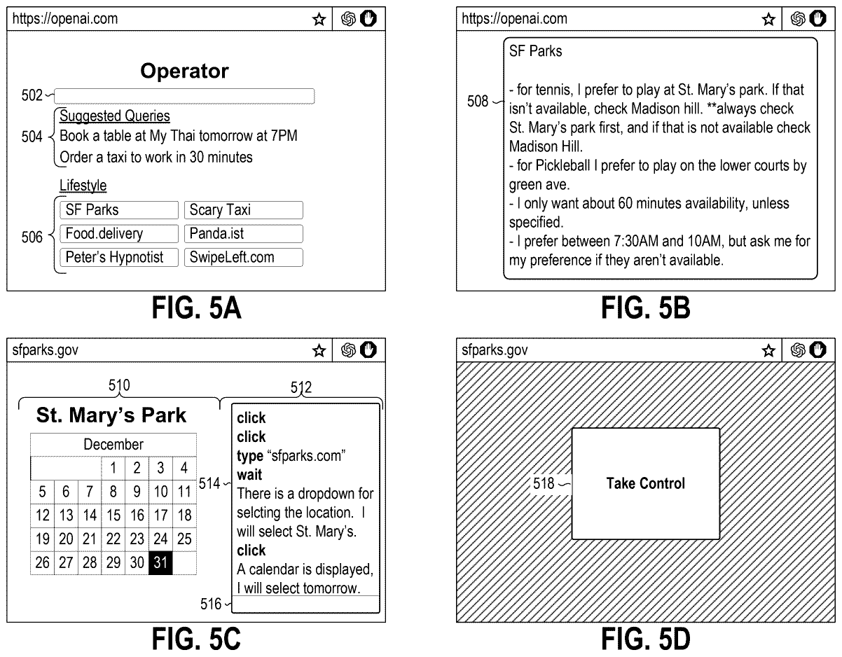

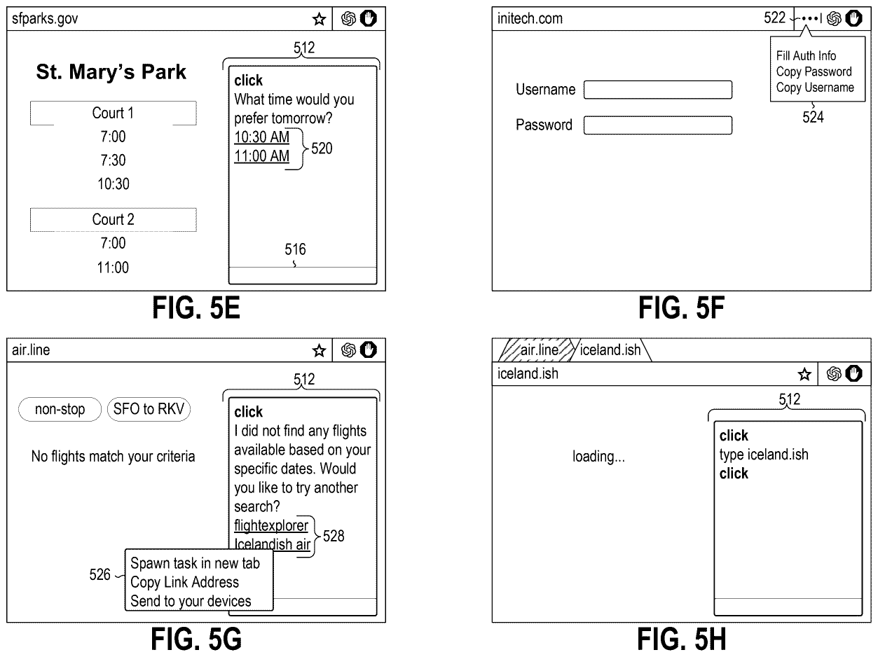

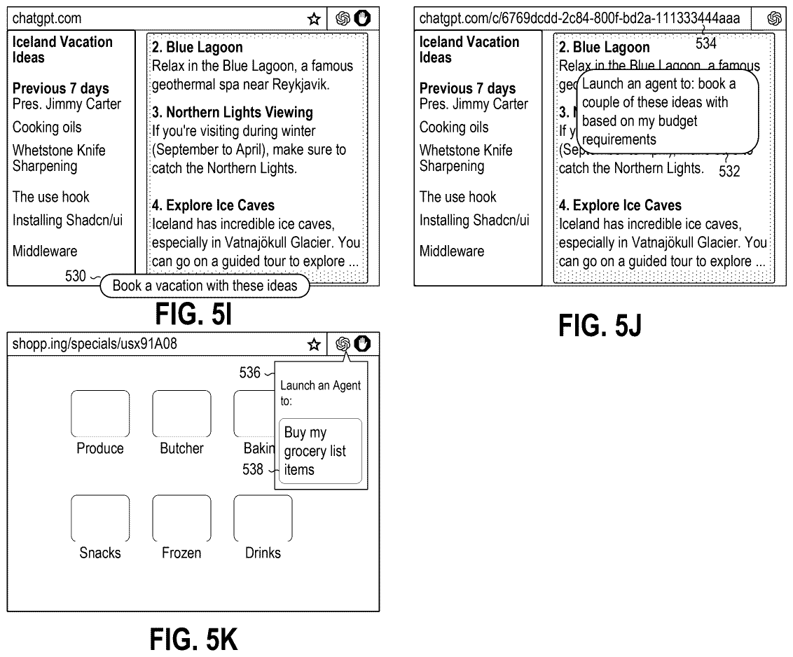

In some aspects, the user of client device 302 may elect to control agent 308. For example, client device 302 may transmit a control request message 326 that is provided in response to a user interface displayed on client device 302 that allows a user to commandeer control of agent 308. The user may request control for various reasons, such as generative response engine 310 not understanding a user interface or inputting bad data. The user of client device 302 can also commandeer control by applying human input device input (e.g., a mouse cursor) in a region (e.g., a viewport of the remote browser) for a threshold period of time, which causes client application to display a user interface control (e.g. a modal with a button in FIG. 5D) to request control. The viewport of a browser is the visible portion of the rendered content as not all rendered content is necessary displayed based on the total size of the rendered content. In other cases, the user may provide a touch input for a period of time to trigger the user interface control.

In response to control request message 326, agent 308 is now under user control. When the agent transitions to user control, agent 308 sends first image 328 to generative response engine 310. First image 328 corresponds to a state of agent 308 before user input is applied. In some aspects, agent 308 is also in a hold period 330 during which agent 308 does not provide images and other content is not provided to generative response engine 310. That is, first image 328 is the last image associated with the generative response engine control and indicates a state before user input.

In some aspects, the user can provide control based on human input devices (e.g., mouse input, touch input, keyboard, etc.) during the user control. For example, agent 308 implements a protocol similar to VNC and allows the user to provide HID input using client device 302. The user can provide multiple inputs, such as entering authentication credentials, navigating to a particular web address, etc.

Client device 302 may transmit a relinquish control message 332 to relinquish control generative response engine 310. In some aspects, relinquish control message 332 may occur in response to an explicit control to grant control to and cause generative response engine 310 to resume control of agent 308. In another case, if a mouse cursor hovers outside an area corresponding to user input of agent 308 for a period of time, client device 302 may determine to relinquish control. Based on the relinquish control message 332, agent 308 may send second image 334 to generative response engine 310. Second image 334 corresponds to the final state after user input has been applied to agent 308 and before generative response engine 310 resumes control.

In some aspects, generative response engine 310 may use first image 328 and second image 334 and update its internal state at block 336. For example, in the case authentication credentials were entered during the user control period, generative response engine 310 may detect a difference such as by observing that a user's authenticated name is displayed. Generative response engine 310 thereby updates its internal state at block 336 and infers the next actions to provide into agent 308. In some aspects, generative response engine 310 may resume operation by sending an API request 338 to agent 308 based on its updated state at block 336. In this case, generative response engine 310 does not receive images corresponding to input of sensitive information such as passwords. At this point, agent 308 can thereby resume transmitting stream of images 340 to generative response engine 310.

That is, during the generative response engine control periods and the user control periods, agent 308 sends a stream of images to client device 302. During the generative response control periods, agent 308 sends a stream of images to generative response engine 310. During the user control periods, the agent sends an image illustrating the state of agent 308 prior to user control (e.g., first image 328) and an image illustrating the state of agent 308 after user control (e.g., second image 334).

In some aspects, during the generative response engine control period, generative response engine 310 can indicate that user control is required (e.g. using an API request 338). For example, generative response engine 310 can request authentication credentials, payment information, payment confirmation, selection of a multiple potential inputs detected by generative response engine 310, and so forth. Agent 308 can receive API request 338, which can include various options identified by generative response engine 310, and send a user input request 342 to client device 302. User input request 342 may include, for example, requests to enter authentication information, selecting various options that comport with the natural language instruction for the user, and so forth. For example, generative response engine 310 may provide different options that comport to the user instruction (e.g., available times for booking a restaurant, etc.).

In response to user input request 342, client device 302 can present the options to the user. In some aspects, user input request 342 can be direct input into a control (e.g., a password control) based on information that the generative response engine is trained to avoid (e.g., the password). In some aspects, user input request 342 can be presented in a chat control that displays a narrative of events by generative response engine 310 at client device 302. Client device 302 responds with user input 344, which agent 308 receives and controls the remote application to enter. For example, user input 344 can be human input device (HID) input information that agent 308 can translate into based on the application (e.g., the browser) executing in agent 308.

In this aspect, client device 302 and generative response engine 310 can control the remote execution of an application such as a browser application based on different interfaces, and allow single control of agent 308.

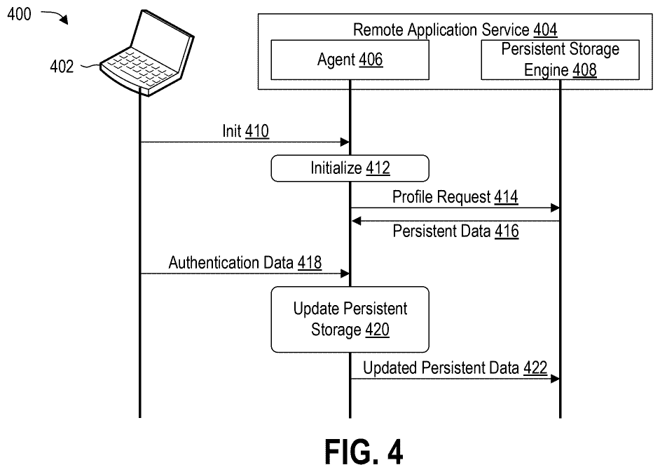

FIG. 4 is a sequence diagram 400 illustrating remote persistent storage for remote application service 404 in accordance with some aspects of the disclosure. Remote application service 404 includes agent 406 (e.g., executing in a containerized environment such as container 210 in FIG. 2) and persistent storage engine 408 configured to persistently store user data for use agents.

In some aspects, client device 402 (e.g., client device 202 of FIG. 2, client device 302 of FIG. 3, etc.) interacting with remote application service 404 may send initialize instruction 410 including a natural language instruction to perform a human action using the remote application. Initialize instruction 410 can have different forms depending on the configuration of the application executing at client device 402. In one aspect, an extension integrated into the browser may send an API request with parameters extracted at client device 402. For example, the extension may determine that a state of a local browser is included in a URI that is available to the extension. In some cases, router-based applications can resume state using the URI. In other cases, a session identifier (such as a universally unique identifier (UUID) is generated can be provided through the API, allowing the remote application service 404 to resume the session. Nonlimiting examples of the natural language instruction can be to book a hotel, book a restaurant, perform a financial or investing transaction, etc. Although initialize instruction 410 is illustrated as being received by agent 406 (e.g., agent 308 of FIG. 3), this to simplify illustrations and a corresponding service (e.g., a management service such as implemented by server 306 in FIG. 3) may cause agent 406 to initialize (e.g., boot) at block 412.

In some aspects, once agent 406 has booted and has retrieved authentication information (e.g., as shown in FIG. 3), agent 406 may connect to persistent storage engine 408 and send profile request 414 to retrieve a profile and corresponding data from persistent storage engine 408. In some aspects, persistent storage engine 408 retrieves the persistent data and any profile information and sends persistent data 416 to agent 406.

In some aspects, persistent storage engine 408 is configured to include multiple storage types for a user profile. For example, persistent storage engine 408 can store cookies that persist small amounts of data between a client (e.g., client device 402) and an external website. For example, cookies are primarily for small pieces of data such as session management, authentication tokens, and user preferences and are generally limited to about 4 KB per cookie, and can be session-based or have an expiration.

Persistent storage engine 408 can also store other types of data, such as key-value data corresponding to the local storage API. Local storage stores larger key-value data that persists across sessions (e.g., about 10 MB) and is generally persistent until explicitly cleared. Persistent storage engine 408 may also store persistent data from the Indexed DB of a local browser. The Indexed DB is configured to store significantly larger contents. In some aspects, persistent storage engine 408 may also store data permitted by a user using various APIs, such as the File System Access API which grants scoped access to a file system based on user permissions.

Persistent storage engine 408 can interface with each of the APIs and may synchronize data between instances of agent 406. For example, client device 402 may send authentication credentials to agent 406, which in turn generates authentication credentials 418 associated with a third-party service (not shown). In some aspects, agent 406 is configured to access a third-party service, receive persistent data, and update and store the persistent storage of agent 406 at block 420. In some aspects, agent 406 may receive a JavaScript web token (JWT) in response to authentication. The JWT is an access token that the third-party services use to validate access and authorization of requests at the third-party service.

In some aspects, persistent storage engine 408 is configured to store persistent data of instances of agent 406. For example, agent 406 can be instrumented to connect to persistent storage engine 408 on a periodic basis to send updated persistent data 422 for persistent storage engine 408 across agent 406 instances. For example, in the event that client device 402 is connected to two different agent 406 instances executing simultaneously, the authentication information (e.g., the JWT) is synchronized at persistent storage engine 408 and shared with other agents 406. In this manner, the remote browsers can have the user's persistent data synchronized so that authentication credentials can persist at different instances, simplifying authentication processes.

FIGS. 5A to 5K illustrate various screenshots of a remote application displayed on a client device in accordance with some aspects of the disclosure. In some aspects, FIG. 5A illustrates a front-end application associated with a remote application service. The front-end application can be rendered based on different techniques (e.g., server-side rendering, client-side rendering, etc.) using different frameworks. In some aspects, the front-end application is used in conjunction with a server to remotely execute a browser application in a virtualized environment (e.g., a container). The front-end application may display text input control 502 for providing a natural language query (e.g., initialization instruction 314 in FIG. 3). The front-end application may also display suggested queries 504 based on historical information and present information (e.g., current time of day based on the user's time zone) and location information. The front-end application may also display suggested web addresses 506 associated with potential queries. In some cases, each web address can be configured with preferences dictated by the user. The preferences may be used in a natural language query to achieve results based on the user's preferences.

FIG. 5B illustrates contextual information (e.g., preferences) provided by a user associated with a web address. In the example illustrated in FIG. 5B, a modal including text input control 508 may be superimposed over the contents (e.g., using the Modal API) to allow a user to customize a query. For example, the user may input preferences into text input control 508 (or text input control 502), and the user input preferences are provided as a part of a query to a generative response engine. In some aspects, user input preferences are stored persistently such as in local storage and may be synchronized across instances using a persistent storage mechanism (e.g., persistent storage engine 408 in FIG. 4).

FIG. 5C illustrates an example of a screenshot provided based on generative response input and illustrates remote view 510 that is rendered by the agent to the user and the generative response engine. The client-side application also displays chat panel 512 including list 514 of user input events by the generative response engine and narrative provided by the generative response engine. For example, the narrative in list 514 indicates that the remote browser clicks to focus on a browser address bar and then types the destination web address. The narrative in list 514 also explains any relevant perceptions in connection with actions it will take, such as selecting a location for the event (e.g., in this case reserving a tennis court). List 514 can also include user-interactable components (e.g., hyperlinks or other elements capable of receiving human input events).

Chat panel 512 may also include text input 516 that is configured to receive a natural language query. In some aspects, the user can type an instruction into text input 516, which will cause the generative response engine to respond to the received instruction.

FIG. 5D illustrates user take over control at the client-side application. For example, the user may hover a cursor over remote view 510 for a predetermined time, which can cause the client-side application to display button 518 in the foreground to take control of the remote application. While button 518 is displayed, the client-side application may blur remote view 510 and chat panel 512.

FIG. 5E illustrates an example of generative response engine relinquishing control based on user input. In this example, the generative response engine has identified several potential options based on the query and now user input is needed to continue. In the illustrated example, the generative response engine has identified courts and times satisfying the natural language instructions and provides a request to the agent, which in turn provides a request to the client-side application. In this case, available times are illustrated as hyperlinks 520 (or other input control components that can respond to mouse, touch, or keyboard events).

FIG. 5F illustrates an example of generative response engine relinquishing control based on user input. In this illustration, the chat panel is omitted for purposes of clarity, and the generative response engine relinquishes control based on requiring the user to enter user authentication credentials. In some aspects, extension 522 may be configured to render an interface including options that links private data of extension 522 (e.g., authentication credentials) to the current web address, and the user may use the extension to interact with the remote browser (e.g., via a human input device). For example, a user interface 524 may allow the user to interact with authentication credentials. In some aspects, the extension 522 may also be executed within the remote browser environment to allow the extension 522 handle tasks based on user input.

FIG. 5G illustrates a client-side applicant and invoking agent instances. In some aspects, the client-side application may include a UI capable of displaying contextual menu 526 using various types of input (e.g., an alternate input such as a right click, a keydown event (e.g., shift) combined with a click, etc.). Contextual menu 526 can include various options, such as ability to open a new tab and execute the same task (or a different task). For example, the spawn task in new tab can cause the browser to instantiate a new tab, which in turn spawns a new container for performing the same task. In this example, contextual menu 526 is part of the client-side application (e.g., invoking the modal API using onContextMenu eventhandlers).

For example, in FIG. 5G, the generative response engine can determine that it cannot complete the task due to unavoidable issues, such as search preferences that are too restrictive based on origination, destination, and flight parameters (e.g., non-stop). In this case, the generative response engine can provide a plurality of options 528, which are modified instructions to continue the search but at, for example, different sites.

FIG. 5H illustrates that a new tab is launched and the client-side application is loading as displayed by the narrative in chat panel 512. In this case, a new container is spawned for the execution of the task. The remove application service supports multiple containers that run in parallel, allowing a user to perform many tasks in parallel. In this case, the tabs illustrated in FIG. 5H are each associated with a corresponding container executing the corresponding task.

FIG. 5I illustrates a transparent overlay application that superimposes a text input control 530 over an application to enable generic linking of applications. Although the base application is illustrated as a browser, native applications can also include links and other controls that can be used by the transparent overlay application to spawn containers using various mechanisms. For example, FIG. 5I shows different events for a vacation in a particular country, and the user may input a request into the text input control 530, which then multiple containers to execute the various tasks.

FIG. 5J illustrates browser-based invoked agent from the browser in accordance with some aspects of the disclosure. In this case, the browser itself may be able to access a session identifier and may render an interface over the viewport to allow a natural language search. In this case, the browser can render a text input modal 532 over the rendered content to then spawn a separate agent in a different tab. In some cases, a session identifier may be expressed in the URL 534. The browser has the entire scope available, including access to local storage, and can spawn a new tab with a corresponding instruction (e.g., using an API request) to spawn a container for the remote browser and include the session identifier to allow the remote browser to interact with the generative response engine in a consistent manner. For example, in FIG. 5J, the generative response engine can reduce the scope of the task by removing mutually exclusive concepts (e.g., summer events and winter events).

FIG. 5K illustrates an extension-based invoked agent from a browser in accordance with some aspects of the disclosure. In this case, the extension may be executing on a local device and has a scope of the current document in the viewport, including the URL. In this case, the extension can render a popover 536 (e.g., using the modal API) with a text input control 538. Executing a text via the text input control 538 may cause the extension to send an API request and spawn a container based on the information that is made available (e.g., the URL, the session identifier if available, etc.).

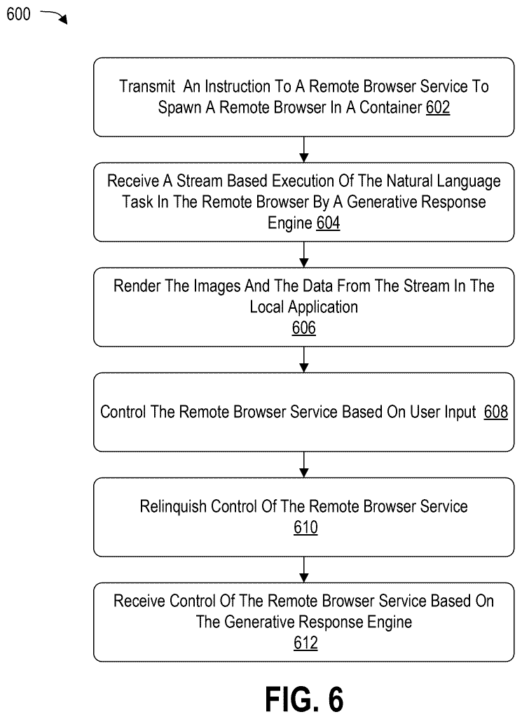

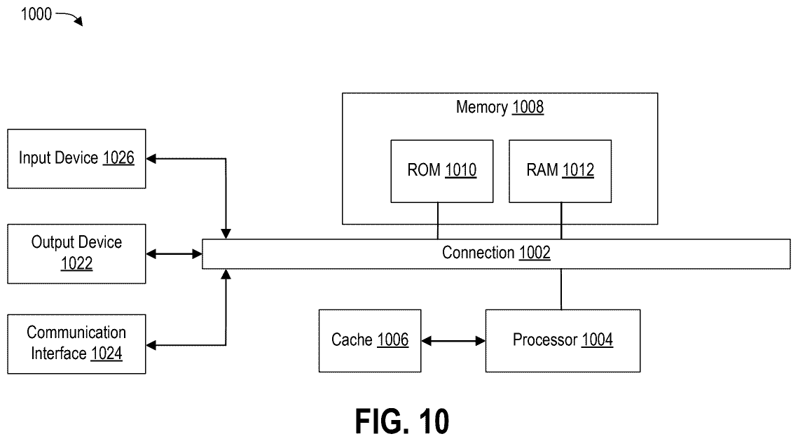

FIG. 6 is a flow diagram of a process 600 for executing a remote application in accordance with some aspects of the disclosure. In some aspects, process 600 is executing on a client device (e.g., the client device 302 of FIG. 3). Process 600 can be performed by a computing device (or apparatus) or a component (e.g., one or more chipsets, a system-on-chip (SoC), one or more processors such as one or more central processing units (CPUs), graphics processing units (GPUs), digital signal processors (DSPs), neural processing units (NPUs), neural signal processors (NSPs), microcontrollers, ASICs, FPGAs, programmable logic devices, discrete gates or transistor logic components, discrete hardware components, etc., an ML system such as a neural network model, any combination thereof, and/or other component or system) of the computing device. The operations of process 600 may be implemented as software components that are executed and run on one or more processors (e.g., CPU, GPU, DSP, NPU or neural engine, SoC, the processor 1004 of FIG. 10, and/or other processor(s)).

In some aspects, the computing device may receive, render, or otherwise display a local application using various rendering techniques. The computing device, based on control from a user, may select contextual information associated with a web address based on an input into the local application and transmit the natural language task associated with the web address with the contextual information to the web address. The contextual information comprises parameters in natural language input obtained from the user and associated with at least one activity associated with the web address. In some cases, the contextual information may also include an API request and can include information that is available, such as a URL route identified by a domain address, a route (or path) and key-value pairs (e.g., xyz.com/login/?key=value) An example of contextual information is described above with reference to FIG. 5B. The contextual information can be combined with the query. For example, the contextual information can be provided as a preamble to improve performance of cached calculations.

At block 602, the computing device may transmit an instruction to a remote browser service to spawn a remote browser in a container. The instruction includes a natural language task for the remote browser to perform at a first address. The first address may be a web address such as a universal resource indicator (URI). For example, the instruction may be a request to find a flight. Additional examples of instructions are described above and below.

At block 604, the computing device may receive a stream based on execution of the task in the remote browser by a generative response engine. The stream includes images illustrating the remote browser and data describing at least events generated by the generative response engine for the remote browser. As described above, a stream is a sequence of data elements made available over time and typically used to process or transmit data incrementally as it is produced or received. A stream is generally processed differently because it can be asynchronous and may require further data. As described above, the computing device receives a generally continuous stream of data from the container (e.g., executing a remote browser).

The data may include user interface events that are generated by the generative response engine and an inner monologue of the generative response engine. As an example, the inner monologue comprises a natural language explanation of an action taken by the generative response engine after a corresponding input by the generative response engine. Non-limiting examples of user interface events include synthetic input events input by the generative response engine such as mouse movements, mouse click events, and typing events.

At block 606, the computing device may render the images and the data from the stream in the local application (e.g., the client-side application). The local application uses the stream to illustrate the remote browser executing in the virtual environment concurrently with synthetic input events (e.g., provided by a generative response engine) and an inner monologue of the generative response engine. The inner monologue provides a summary to the user to allow the user to take control in the event that the generative response engine is unable to complete a sub-task correctly.

For example, as part of block 606, the computing device may display the user interface events and the inner monologue in a sequential list. An example of a sequential list is shown in FIG. 5C. In some aspects, at least a current sub-task described by the inner monologue includes inputs for controlling the current sub-task. For example, inputs for controlling the current sub-task are illustrated in FIG. 5E.

At block 608, the computing device may control the remote browser service based on user input. As an example of block 608, the computing device may receive a first input to assert control of the remote browser at the local application. An example of a first input can be a button to assert control as illustrated in FIG. 5D. The user device, based on the control of the user, may provide an instruction to control the remote browser from the local application based on the first input.

At part of block 608, the computing device may also receive a second input associated with a first image representing a current state remote browser at the local application. The user may select an interactable user interface element (e.g., a button) and thereby cause the computing device to transmit information describing the second input to the remote browser and then receive a second image illustrating the remote browser based on a response to the second input.

In some aspects, as part of block 608, the computing device can receive an input associated with an extension application that can access at least a part of the local application through an interface. For example, the local application may generate input controls in a non-visible manner (e.g., off-screen coordinates) that can be accessible to the extension application. The computing device can intercept the input and transmit the input to the remote browser, thereby allowing the extension application and the local application to coordinate in a seamless manner that is transparent to the user (e.g., does not require any additional user input).

At block 610, the computing device may relinquish control of the remote browser service. In some aspects, the user may be completed with user input and receive a third input to relinquish control of the remote browser at the local application. The computing device then transmits an instruction to the remote browser to relinquish control of the remote browser at the local application. In some cases, the first image and the second image (or a variant thereof from the remote application service) can send images corresponding to the first image (e.g., before user input) and the second image (e.g., after user input).

At block 612, the computing device may receive control of the remote browser service. In some aspects, the computing device may identify a human input request in the stream based on the completion of a sub-task of the natural language task. The human input request indicates the generative response engine has relinquished control of the remote browser. For example, the generative response engine may have completed part of a sub-task and requires further user input, such as selecting a time as illustrated in FIG. 5E. In another example, the generative response engine may require user authentication credentials as illustrated in FIG. 5F. Based on an input responsive to the human input request, the computing device may transmit information to the remote corresponding to the input. In response to the input, the generative response engine may reassert control to continue various sub-tasks associated with the natural language task.

In some aspects, the computing device may transmit an instruction to the remote browser service to spawn a second remote browser in a second container. The instruction may include a second natural language task for the second remote browser to perform at a second address. A server or service is configured to spawn the second remote browser in the second container. In some aspects, the second container may receive persistent state information created at the remote browser. For example, the user may have entered authentication information associated with a first web address. The instruction may be to perform a different task at the first web address, and the second container may receive a cookie from a persistent data storage service of the remote application service with the authentication token created in connection with the first container. In this manner, the remote application service can generate a remote profile of the user and persist various types of application data for seamless execution of tasks.

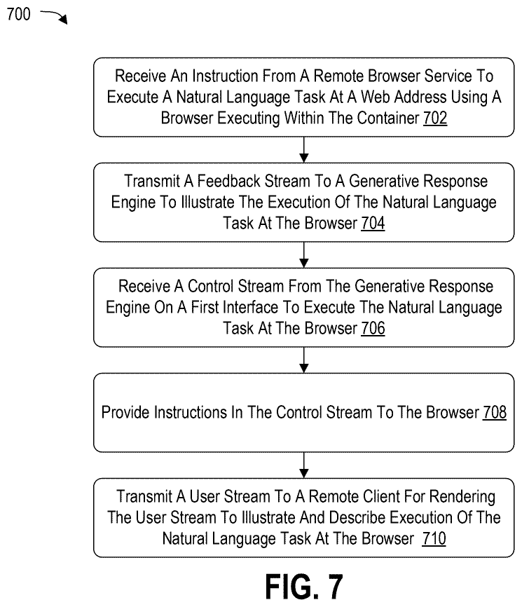

FIG. 7 is a flow diagram of a process for executing a remote application by an agent in accordance with some aspects of the disclosure. Process 700 can be performed by a computing device (or apparatus) or a component (e.g., one or more chipsets, a SoC, one or more processors such as one or more CPUs, GPUs, DSPs, NPUs, NSPs, microcontrollers, ASICs, FPGAs, programmable logic devices, discrete gates or transistor logic components, discrete hardware components, etc., an ML system such as a neural network model, any combination thereof, and/or other component or system) of the computing device. The operations of process 700 may be implemented as software components that are executed and run on one or more processors (e.g., CPU, GPU, DSP, NPU or neural engine, SoC, the processor 1004 of FIG. 10, and/or other processor(s)).

In some aspects, a service that is configured to manage agents may receive an instruction to instantiate a container including the agent. For example, the service can be a management service for managing containers of the remote browser service. In some aspects, the service can initiate a container and a remote browser within an environment (e.g., OS) of the container. As part of initiating the container, the container may receive a persistent user state associated with a user identifier from a persistent data store based on a request from the container. For example, the container can receive authentication information (e.g., a JWT) including the user identifier and the container may use the authentication to retrieve the persistent data (e.g., from persistent storage engine 408 in FIG. 4). The persistent user state comprises persistent data accumulated from previous or concurrent containers (e.g., previous authentications). The computing system may update a local persistent state of the browser based on the persistent user state.

At block 702, the computing system may receive an instruction from a remote browser service to execute a natural language task at a web address (e.g., a URI) using a browser executing within the container. For example, a natural language task can be to purchase items on a grocery list from a service associated with the web address.

At block 704, the computing system may transmit a feedback stream to a generative response engine to illustrate the execution of the natural language task at the browser. For example, the computing system can capture an image illustrating that the browser is displaying a blank page or a default page. The generative response engine can ascertain that the mouse should be moved to a coordinate associated with the address bar so that the address can be input.

At block 706, the computing system may receive, by the agent, a control stream from the generative response engine on a first interface to execute the natural language task at the browser. The control stream comprises various information provided by the generative response engine. For example, the computing system may identify synthetic input events in the control stream corresponding to inputs from human input devices. In some cases, as further described below, the synthetic input events may be provided to the client device in a user stream.

In some cases, the generative response engine may be configured to provide programmatic events based on a document object model (DOM) to the browser. For example, the agent may include a DOM interface that the generative response engine may invoke.

As part of block 706, the computing system may receive an inner monologue from the generative response engine. The inner monologue may be natural language from the generative response engine identifying its current state. As described below, the inner monologue (or a summary thereof) may be provided to the client device to narrate the execution of the task by the generative response engine.

In some aspects of block 708, the computing system may provide instructions to the browser to authenticate with corresponding authentication information. In response, the browser may use an authentication token and modify a local persistent state which, as described below, may be provided to a persistent data store.

At block 710, the computing system may transmit a user stream to a remote client for rendering the user stream to illustrate and describe the execution of the natural language task at the browser. For example, the user stream may identify the synthetic input events provided to the browser from the generative response engine. The user stream may also include the inner monologue or a summary of the inner monologue. The inner monologue may be too detailed or could reveal sensitive information and may be summarized to reduce extraneous and sensitive information.

In some aspects, the computing system may receive a first input to assert control of the browser from the remote client. The agent is configured to pause transmission of the feedback stream when the remote client asserts control and provides an instruction to the generative response engine to pause inference. Based on receiving a second input from the remote client, the computing system may provide the second input to the browser. In some aspects, the user stream includes at least two images illustrating the execution of the browser based on the second input (e.g., before input and after input).

In some aspects, the computing system may receive a third input to relinquish control of the browser at the remote client. In this case, the computing system may then transmit the at least two images to the generative response engine with an instruction to resume inference based on changes between the at least two images. The computing system may then resume transmission of the feedback stream to the generative response engine.

In some aspects, the computing device may also receive a request for human input from the generative response engine. The computing device may, based on receiving a request for human input from the generative response engine, transmit a human input request to the remote client and then receive a response to the human input request from the remote client. For example, the input can be selecting a time for an event (e.g., FIG. 5E) or authentication information (e.g., FIG. 5F). The computing system may provide an input to the browser based on the response including an instruction corresponding to a human input device in the browser and provide a response to the generative response engine based on the response including information requested in the human input request.

In some aspects, the input from the user can change persistent storage information by, for example, generating a JWT with authentication information. For example, if the browser generates persistent state information to update a local persistent state of the browser based on the response, the computing system may provide the persistent state information to a persistent data store (e.g., persistent storage engine 408 in FIG. 4).

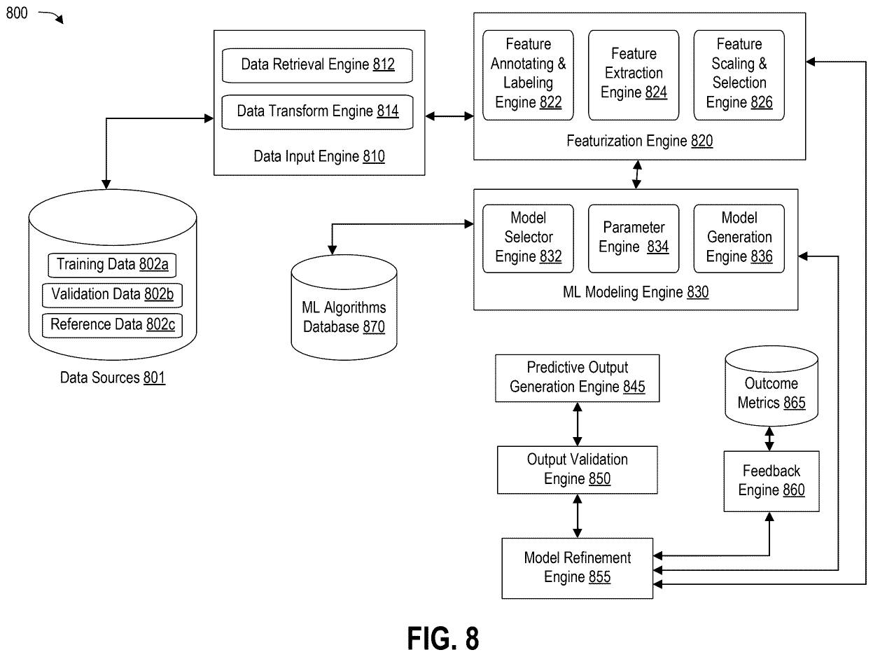

FIG. 8 is a block diagram illustrating an example machine learning platform for implementing various aspects of this disclosure in accordance with some aspects of the present technology. Although the example system depicts particular system components and an arrangement of such components, this depiction is to facilitate a discussion of the present technology and should not be considered limiting unless specified in the appended claims. For example, some components that are illustrated as separate can be combined with other components, and some components can be divided into separate components.

System 800 may include data input engine 810 that can further include data retrieval engine 812 and data transform engine 814. Data retrieval engine 812 may be configured to access, interpret, request, or receive data, which may be adjusted, reformatted, or changed (e.g., to be interpretable by another engine, such as data input engine 810). For example, data retrieval engine 812 may request data from a remote source using an API. Data input engine 810 may be configured to access, interpret, request, format, re-format, or receive input data from data sources(s) 801. For example, data input engine 810 may be configured to use data transform engine 814 to execute a re-configuration or other change to data, such as a data dimension reduction. In some embodiments, data sources(s) 801 may be associated with a single entity (e.g., organization) or with multiple entities. Data sources(s) 801 may include one or more of training data 802a (e.g., input data to feed a machine learning model as part of one or more training processes), validation data 802b (e.g., data against which at least one processor may compare model output with, such as to determine model output quality), and/or reference data 802c. In some embodiments, data input engine 810 can be implemented using at least one computing device. For example, data from data sources(s) 801 can be obtained through one or more I/O devices and/or network interfaces. Further, the data may be stored (e.g., during execution of one or more operations) in a suitable storage or system memory. Data input engine 810 may also be configured to interact with a data storage, which may be implemented on a computing device that stores data in storage or system memory.

System 800 may include featurization engine 820. Featurization engine 820 may include feature annotating and labeling engine 822 (e.g., configured to annotate or label features from a model or data, which may be extracted by feature extraction engine 824), feature extraction engine 824 (e.g., configured to extract one or more features from a model or data), and/or feature scaling and selection engine 826. Feature scaling and selection engine 826 may be configured to determine, select, limit, constrain, concatenate, or define features (e.g., AI features) for use with AI models.

System 800 may also include machine learning (ML) ML modeling engine 830, which may be configured to execute one or more operations on a machine learning model (e.g., model training, model re-configuration, model validation, model testing), such as those described in the processes described herein. For example, ML modeling engine 830 may execute an operation to train a machine learning model, such as adding, removing, or modifying a model parameter. Training of a machine learning model may be supervised, semi-supervised, or unsupervised. In some embodiments, training of a machine learning model may include multiple epochs, or passes of data (e.g., training data 802a) through a machine learning model process (e.g., a training process). In some embodiments, different epochs may have different degrees of supervision (e.g., supervised, semi-supervised, or unsupervised). Data into a model to train the model may include input data (e.g., as described above) and/or data previously output from a model (e.g., forming a recursive learning feedback). A model parameter may include one or more of a seed value, a model node, a model layer, an algorithm, a function, a model connection (e.g., between other model parameters or between models), a model constraint, or any other digital component influencing the output of a model. A model connection may include or represent a relationship between model parameters and/or models, which may be dependent or interdependent, hierarchical, and/or static or dynamic. The combination and configuration of the model parameters and relationships between model parameters discussed herein are cognitively infeasible for the human mind to maintain or use. Without limiting the disclosed embodiments in any way, a machine learning model may include millions, billions, or even trillions of model parameters. ML modeling engine 830 may include model selector engine 832 (e.g., configured to select a model from among a plurality of models, such as based on input data), parameter engine 834 (e.g., configured to add, remove, and/or change one or more parameters of a model), and/or model generation engine 836 (e.g., configured to generate one or more machine learning models, such as according to model input data, model output data, comparison data, and/or validation data).

In some embodiments, model selector engine 832 may be configured to receive input and/or transmit output to ML algorithms database 870. Similarly, featurization engine 820 can utilize storage or system memory for storing data and can utilize one or more I/O devices or network interfaces for transmitting or receiving data. ML algorithms database 870 may store one or more machine learning models, any of which may be fully trained, partially trained, or untrained. A machine learning model may be or include, without limitation, one or more of (e.g., such as in the case of a metamodel) a statistical model, an algorithm, a neural network (NN), a convolutional neural network (CNN), a generative neural network (GNN), a Word2Vec model, a bag of words model, a term frequency-inverse document frequency (tf-idf) model, a GPT (Generative Pre-trained Transformer) model (or other autoregressive model), a diffusion model, a diffusion-transformer model, an encoder such as BERT (Bidirectional Encoder Representations from Transformers) or LXMERT (Learning Cross-Modality Encoder Representations from Transformers), a Proximal Policy Optimization (PPO) model, a nearest neighbor model (e.g., k nearest neighbor model), a linear regression model, a k-means clustering model, a Q-Learning model, a Temporal Difference (TD) model, a Deep Adversarial Network model, or any other type of model described further herein. Some of the ML algorithms in ML algorithms database 870 can be considered generative response engines. Generative response engines are those models are commonly referred to as Generative AI, and that can receive an input prompt and generate additional content based on the prompt. GPTs, diffusion models, and diffusion-transformer models are some non-limiting examples of generative response engines. Some specific examples of generative response engines that can be stored in the ML algorithms database 870 include versions DALLE, CHAT GPT, and SORA, all provided by OPEN AI.

System 800 can further include predictive output generation engine 845 and output validation engine 850 (e.g., configured to apply validation data to machine learning model output). Predictive output generation engine 845 can analyze the input and identify relevant patterns and associations in the data it has learned to generate a sequence of words that predictive output generation engine 845 predicts is the most likely continuation of the input using one or more models from the ML algorithms database 870, aiming to provide a coherent and contextually relevant answer. Predictive output generation engine 845 generates responses by sampling from the probability distribution of possible words and sequences, guided by the patterns observed during its training. In some embodiments, predictive output generation engine 845 can generate multiple possible responses before presenting the final one. Predictive output generation engine 845 can generate multiple responses based on the input, and these responses are variations that predictive output generation engine 845 considers potentially relevant and coherent. Output validation engine 850 can evaluate these generated responses based on certain criteria. These criteria can include relevance to the prompt, coherence, fluency, and sometimes adherence to specific guidelines or rules, depending on the application. Based on this evaluation, output validation engine 850 selects the most appropriate response. This selection is typically the one that scores highest on the set criteria, balancing factors like relevance, informativeness, and coherence.

System 800 can further include feedback engine 860 (e.g., configured to apply feedback from a user and/or machine to a model) and model refinement engine 855 (e.g., configured to update or re-configure a model). In some embodiments, feedback engine 860 may receive input and/or transmit output (e.g., output from a trained, partially trained, or untrained model) to outcome metrics database 865. Outcome metrics database 865 may be configured to store output from one or more models and may also be configured to associate output with one or more models. In some embodiments, outcome metrics database 865, or other device (e.g., model refinement engine 855 or feedback engine 860), may be configured to correlate output, detect trends in output data, and/or infer a change to input or model parameters to cause a particular model output or type of model output. In some embodiments, model refinement engine 855 may receive output from predictive output generation engine 845 or output validation engine 850. In some embodiments, model refinement engine 855 may transmit the received output to featurization engine 820 or ML modeling engine 830 in one or more iterative cycles.

The engines of system 800 may be packaged functional hardware units designed for use with other components or a part of a program that performs a particular function (e.g., of related functions). Any or each of these modules may be implemented using a computing device. In some embodiments, the functionality of system 800 may be split across multiple computing devices to allow for distributed processing of the data, which may improve output speed and reduce computational load on individual devices. In some embodiments, system 800 may use load-balancing to maintain stable resource load (e.g., processing load, memory load, or bandwidth load) across multiple computing devices and to reduce the risk of a computing device or connection becoming overloaded. In these or other embodiments, the different components may communicate over one or more I/O devices and/or network interfaces.

System 800 can be related to different domains or fields of use. Descriptions of embodiments related to specific domains, such as natural language processing or language modeling, is not intended to limit the disclosed embodiments to those specific domains, and embodiments consistent with the present disclosure can apply to any domain that utilizes predictive modeling based on available data.

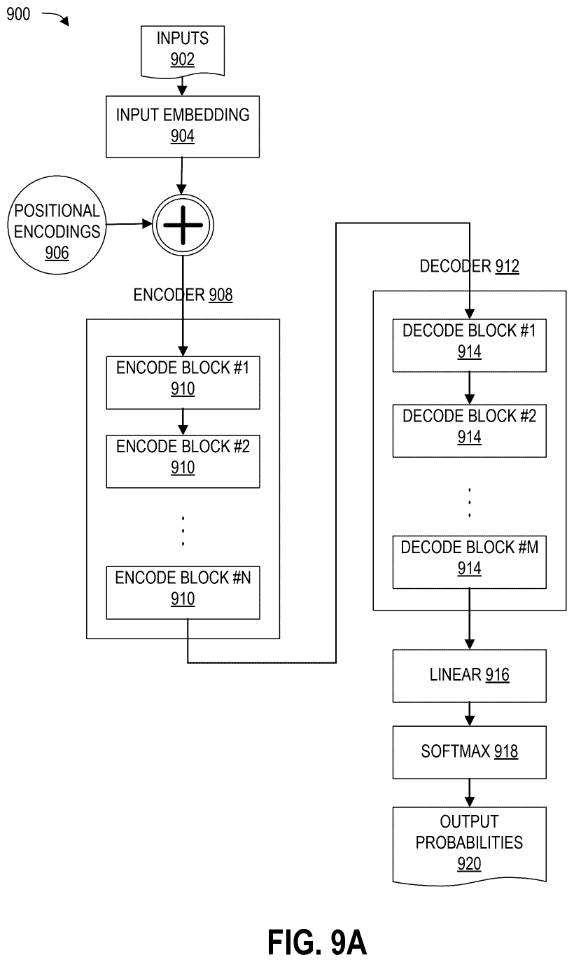

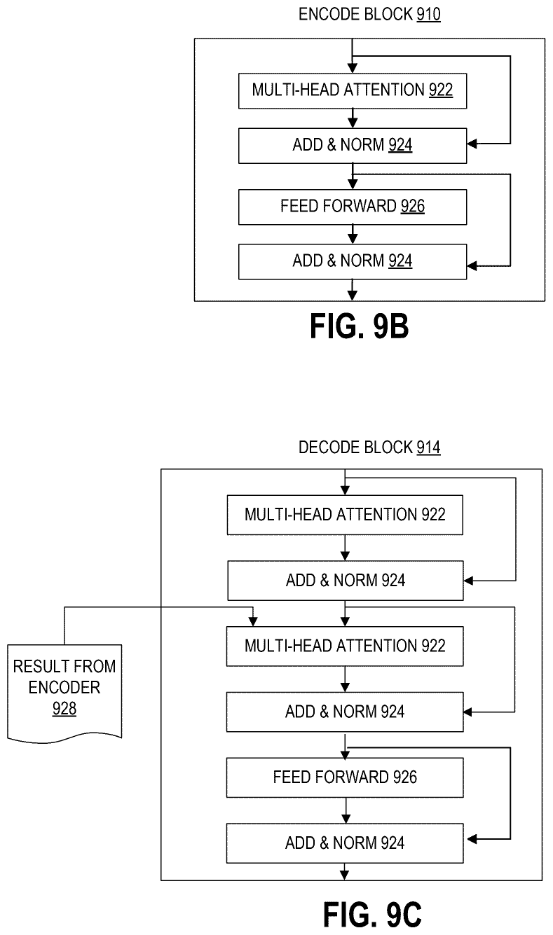

FIG. 9A, FIG. 9B, and FIG. 9C illustrates an example transformer architecture in accordance with some embodiments of the present technology. Examples of ML models that use a transformer neural network (e.g., transformer architecture 900) can include, e.g., generative pretrained transformer (GPT) models and Bidirectional Encoder Representations from Transformer (BERT) models. The transformer architecture 900, which is illustrated in FIG. 9A, FIG. 9B, and FIG. 9C, includes inputs 902, input embedding block 904, positional encodings 906, encoder 908 including encode blocks 910, decoder 912 including decode blocks 914, linear block 916, softmax block 918, and output probabilities 920.

Input embedding block 904 is used to provide representations for words. For example, embedding can be used in text analysis. According to certain non-limiting examples, the representation is a real-valued vector that encodes the meaning of the word in such a way that words that are closer in the vector space are expected to be similar in meaning. Word embeddings can be obtained using language modeling and feature learning techniques, where words or phrases from the vocabulary are mapped to vectors of real numbers. According to certain non-limiting examples, the input embedding block 904 can be learned embeddings to convert the input tokens and output tokens to vectors of dimension that have the same dimension as the positional encodings, for example.

Positional encodings 906 provide information about the relative or absolute position of the tokens in the sequence. According to certain non-limiting examples, positional encodings 906 can be provided by adding positional encodings to the input embeddings at the inputs to the encoder 908 and decoder 912. The positional encodings have the same dimension as the embeddings, thereby enabling a summing of the embeddings with the positional encodings. There are several ways to realize the positional encodings, including learned and fixed. For example, sine and cosine functions having different frequencies can be used. That is, each dimension of the positional encoding corresponds to a sinusoid. Other techniques of conveying positional information can also be used, as would be understood by a person of ordinary skill in the art. For example, learned positional embeddings can instead be used to obtain similar results. An advantage of using sinusoidal positional encodings rather than learned positional encodings is that doing so allows the model to extrapolate to sequence lengths longer than the ones encountered during training.

Encoder 908 can use stacked self-attention and point-wise, fully connected layers. Encoder 908 can be a stack of N identical layers (e.g., N=6), and each layer can be an encode block, as illustrated by encode block 910 shown in FIG. 9B. Each encode block 910 has two sub-layers: (i) a first sub-layer has a multi-head attention block 922 and (ii) a second sub-layer has a feed forward block 926, which can be a position-wise fully connected feed-forward network. The feed forward block 926 can use a rectified linear unit (ReLU).

Encoder 908 uses a residual connection around each of the two sub-layers, followed by an add and norm block 924, which performs normalization. For example, the output of each sub-layer can be LayerNorm(x+Sublayer(x)). To facilitate these residual connections, all sub-layers in the model, as well as the embedding layers, produce output data having a same dimension.

Similar to encoder 908, decoder 912 uses stacked self-attention and point-wise, fully connected layers. Decoder 912 can also be a stack of M identical layers (e.g., M=6), and each layer can be a decode block, as illustrated by decode block 912 shown in FIG. 9B. In addition to the two sub-layers (i.e., the sublayer with multi-head attention block 922 and the sub-layer with feed forward block 926) found in encode block 910, decode block 914 can include a third sub-layer, which performs multi-head attention over the output of the encoder stack. Similar to encoder 908, decoder 912 uses residual connections around each of the sub-layers, followed by layer normalization. Additionally, the sub-layer with multi-head attention block 922 can be modified in the decoder stack to prevent positions from attending to subsequent positions. This masking, combined with the fact that the output embeddings are offset by one position, can ensure that the predictions for position i can depend only on the known output data at positions less than i.

Linear block 916 can be a learned linear transformation. For example, when transformer architecture 900 is being used to translate from a first language into a second language, linear block 916 can project the output from the last decode softmax block 918 into word scores for the second language (e.g., a score value for each unique word in the target vocabulary) at each position in the sentence. For instance, if the output sentence has seven words and the provided vocabulary for the second language has 10,000 unique words, then 10,000 score values are generated for each of those seven words. The score values indicate the likelihood of occurrence for each word in the vocabulary in that position of the sentence.

Softmax block 918 then turns the scores from linear block 916 into output probabilities 920 (which add up to 1.0). In each position, the index provides for the word with the highest probability, and then maps that index to the corresponding word in the vocabulary. Those words then form the output sequence of transformer architecture 900. The softmax operation is applied to the output from linear block 916 to convert the raw numbers into output probabilities 920 (e.g., token probabilities).

FIG. 10 shows an example of computing system 1000, which can be, for example, any computing device making up any engine illustrated in FIG. 1 or any component thereof.

In some embodiments, computing system 1000 is a single device, or a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

In some embodiments, computing system 1000 may comprise one or more computing resources provisioned from a “cloud computing” provider, For example, AMAZON ELASTIC COMPUTE CLOUD (“AMAZON EC2”), provided by AMAZON, INC. of Seattle, Washington; SUN CLOUD COMPUTER UTILITY, provided by SUN MICROSYSTEMS, INC. of Santa Clara, California; AZURE, provided by MICROSOFT CORPORATION of Redmond, Washington, GOOGLE CLOUD PLATFORM, provided by ALPHABET, INC. of Mountain View, California, and the like.

Example computing system 1000 includes at least one processing unit (CPU or processor) 1004 and connection 1002 that couples various system components including system memory 1008, such as read-only memory (ROM) 1010 and random access memory (RAM) 1012 to processor 1004. Memory 1008 can be a volatile or non-volatile memory device, and can be a hard disk or other types of non-transitory computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

Memory 1008 can include software services, servers, logic, etc., that when the code that defines such software is executed by the processor 1004, it causes the system to perform a function. In some embodiments, a hardware service that performs a particular function can include the software component stored in a computer-readable medium in connection with the necessary hardware components, such as processor 1004, connection 1002, output device 1022, etc., to carry out the function.

Computing system 1000 can include a cache of high-speed memory 1006 connected directly with, in close proximity to, or integrated as part of processor 1004.

Connection 1002 can be a physical connection via a bus, or a direct connection into processor 1004, such as in a chipset architecture. Connection 1002 can also be a virtual connection, networked connection, or logical connection.

Processor 1004 can include any general purpose processor and a hardware service or software service stored in memory 1008, configured to control processor 1004 as well as a special-purpose processor where software instructions are incorporated into the actual processor design. Processor 1004 may essentially be a completely self-contained computing system, containing multiple cores or processors, a bus, memory controller, cache, etc. A multi-core processor may be symmetric or asymmetric. Processor 1004 can be physical or virtual.

To enable user interaction, computing system 1000 includes an input device 1026, which can represent any number of input mechanisms, such as a microphone for speech, a touch-sensitive screen for gesture or graphical input, keyboard, mouse, motion input, speech, etc. Computing system 1000 can also include output device 1022, which can be one or more of a number of output mechanisms known to those of skill in the art. In some instances, multimodal systems can enable a user to provide multiple types of input/output to communicate with computing system 1000. Computing system 1000 can include communication interface 1024, which can generally govern and manage the user input and system output. There is no restriction on operating on any particular hardware arrangement, and therefore the basic features here may easily be substituted for improved hardware or firmware arrangements as they are developed.

In some embodiments, computing system 1000 can refer to a combination of a personal computing device interacting with components hosted in a data center, where both the computing device and the components in the data center. In such examples, both the personal computing device and the components in the datacenter might have a processor, cache, memory, storage, etc.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, For example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

### Aspects

The present technology includes computer-readable storage mediums for storing instructions, and systems for executing any one of the methods embodied in the instructions addressed in the aspects of the present technology presented below:

Aspect 1. A method for interacting with a remote browser from a client device, comprising: transmitting, from a local application, an instruction to a remote browser service to spawn a remote browser in a container, wherein the instruction includes a task for the remote browser to perform at a first address; receiving, by the local application, a stream based on execution of the task in the remote browser by a generative response engine, wherein the stream includes images illustrating the remote browser and data describing at least events generated by the generative response engine for the remote browser; and rendering the images and the data from the stream in the local application.

Aspect 2. The method of Aspect 1, further comprising: selecting contextual information associated with a web address based on an input into the local application, wherein the contextual information comprises parameters in natural language input obtained from and user associated with at least one activity associated with the web address; and transmitting the natural language task associated with the web address with the contextual information to the web address.

Aspect 3. The method of any of Aspects 1 to 2, wherein the data comprises user interface events provided by the generative response engine and an inner monologue, wherein the inner monologue comprises a natural language explanation of an action taken by the generative response engine based on a corresponding input by the generative response engine.

Aspect 4. The method of Aspect 3, further comprising: displaying the user interface events and the inner monologue in a sequential list, wherein at least a current sub-task described by the inner monologue includes inputs for controlling the current sub-task.

Aspect 5. The method of any of Aspects 1 to 4, further comprising: receiving a first input to assert control of the remote browser at the local application; providing an instruction to control the remote browser from the local application based on the first input.

Aspect 6. The method of any of Aspects 1 to 5, further comprising: receiving a second input associated with a first image representing a current state of the remote browser at the local application; transmitting information describing the second input to the remote browser; receiving a second image illustrating the remote browser based on a response to the second input.

Aspect 7. The method of Aspect 6, further comprising: receiving a third input to relinquish control of the remote browser at the local application; and transmitting an instruction to the remote browser to relinquish control of the remote browser at the local application.

Aspect 8. The method of any of Aspects 1 to 7, further comprising: transmitting an instruction to the remote browser service to spawn a second remote browser in a second container, wherein the instruction includes a second natural language task for the second remote browser to perform at a second address, wherein the second container receives a persistent state information created at the remote browser.

Aspect 9. The method of any of Aspects 1 to 8, further comprising: identifying a human input request in the stream based on completion of a sub-task of the natural language task, wherein the human input request indicates the generative response engine has relinquished control of the remote browser; based on an input responsive to the human input request, transmitting information to the remote corresponding to the input, wherein the generative response engine asserts control in response to the input.

Aspect 10. A computing device for interacting with a remote browser from the computing device. The computing device includes at least one memory and at least one processor coupled to the at least one memory and configured to: transmit an instruction to a remote browser service to spawn a remote browser in a container, wherein the instruction includes a task for the remote browser to perform at a first address; receive a stream based on execution of the task in the remote browser by a generative response engine, wherein the stream includes images illustrating the remote browser and data describing at least events generated by the generative response engine for the remote browser; and render the images and the data from the stream in the local application.

Aspect 11. The computing device of Aspect 10, wherein the at least one processor is configured to: select contextual information associated with a web address based on an input into the local application, wherein the contextual information comprises parameters in natural language input obtained from and user associated with at least one activity associated with the web address; and transmit the natural language task associated with the web address with the contextual information to the web address.

Aspect 12. The computing device of any of Aspects 10 to 11, wherein the data comprises user interface events provided by the generative response engine and an inner monologue, wherein the inner monologue comprises a natural language explanation of an action taken by the generative response engine based on a corresponding input by the generative response engine.

Aspect 13. The computing device of Aspect 12, wherein the at least one processor is configured to: display the user interface events and the inner monologue in a sequential list, wherein at least a current sub-task described by the inner monologue includes inputs for controlling the current sub-task.

Aspect 14. The computing device of any of Aspects 10 to 13, wherein the at least one processor is configured to: receive a first input to assert control of the remote browser at the local application; and provide an instruction to control the remote browser from the local application based on the first input.

Aspect 15. The computing device of any of Aspects 10 to 14, wherein the at least one processor is configured to: receive a second input associated with a first image representing a current state of the remote browser at the local application; transmit information describing the second input to the remote browser; and receive a second image illustrating the remote browser based on a response to the second input.

Aspect 16. The computing device of Aspect 15, wherein the at least one processor is configured to: receive a third input to relinquish control of the remote browser at the local application; and transmit an instruction to the remote browser to relinquish control of the remote browser at the local application.

Aspect 17. The computing device of any of Aspects 10 to 16, wherein the at least one processor is configured to: transmit an instruction to the remote browser service to spawn a second remote browser in a second container, wherein the instruction includes a second natural language task for the second remote browser to perform at a second address, wherein the second container receives a persistent state information created at the remote browser.

Aspect 18. The computing device of any of Aspects 10 to 17, wherein the at least one processor is configured to: identify a human input request in the stream based on completion of a sub-task of the natural language task, wherein the human input request indicates the generative response engine has relinquished control of the remote browser; and based on an input responsive to the human input request, transmit information to the remote corresponding to the input, wherein the generative response engine asserts control in response to the input.

Aspect 19. A non-transitory computer-readable medium having stored thereon instructions that, when executed by at least one processor, cause the at least one processor to perform operations according to any of Aspects 1 to 9.

Aspect 20. An apparatus, comprising one or more means for performing operations according to any of Aspects 1 to 9.

Aspect 21. A method of a control service configured to execute in a container, comprising: receiving, at an agent associated with a container, an instruction from a remote browser service to execute a natural language task at a web address using a browser executing within the container; transmitting, by the agent, a feedback stream to a generative response engine to illustrate the execution of the natural language task at the browser; receiving, by the agent, a control stream from the generative response engine on a first interface to execute the natural language task at the browser; providing, by the agent, instructions in the control stream to the browser; and transmitting a user stream to a remote client for rendering the user stream to illustrate and describe execution of the natural language task at the browser.

Aspect 22. The method of Aspect 21, further comprising: receiving persistent user state associated with a user identifier from a persistent data store based on a request from the container, wherein the persistent user state comprises persistent data accumulated from previous containers; and updating a local persistent state of the browser based on the persistent user state.

Aspect 23. The method of any of Aspects 21 to 22, further comprising: identifying synthetic input events in the control stream corresponding to inputs from human input devices, wherein the user stream identifies the synthetic input events provided to the browser.

Aspect 24. The method of Aspect 23, further comprising: receiving an inner monologue from the generative response engine, wherein the user stream includes a summary of the inner monologue.

Aspect 25. The method of any of Aspects 21 to 24, further comprising: receiving a first input to assert control of the browser from the remote client, wherein the agent is configured to pause transmission of the feedback stream when the remote client asserts control; and providing an instruction to the generative response engine to pause inference.

Aspect 26. The method of Aspect 25, further comprising: based on receiving a second input from the remote client, providing the second input to the browser, wherein the user stream includes at least two images illustrating the execution of the browser based on the second input.

Aspect 27. The method of Aspect 26, further comprising: receiving a third input to relinquish control of the browser at the remote client; transmitting the at least two images to the generative response engine with an instruction to resume inference based on changes between the at least two images; and resuming transmission of the feedback stream to the generative response engine.

Aspect 28. The method of any of Aspects 21 to 27, further comprising: based on receiving a request for human input from the generative response engine, transmitting a human input request to the remote client; receiving a response to the human input request from the remote client; providing an input to the browser based on the response including an instruction corresponding to a human input device in the browser; and providing a response to the generative response engine based on the response including information requested in the human input request.

Aspect 29. The method of Aspect 28, further comprising: if the browser generates persistent state information to update a local persistent state of the browser based on the response, providing the persistent state information to a persistent data store.

Aspect 30. A computing device for executing a browser in a containerized environment. The computing device includes at least one memory and at least one processor coupled to the at least one memory and configured to:

Aspect 31. A computing device for configured to execute a control service in a container. The computing device includes at least one memory and at least one processor coupled to the at least one memory and configured to: receive, at an agent associated with a container, an instruction from a remote browser service to execute a natural language task at a web address using a browser executing within the container; transmit, by the agent, a feedback stream to a generative response engine to illustrate the execution of the natural language task at the browser; receive, by the agent, a control stream from the generative response engine on a first interface to execute the natural language task at the browser; provide, by the agent, instructions in the control stream to the browser; and transmit a user stream to a remote client for rendering the user stream to illustrate and describe execution of the natural language task at the browser.

Aspect 32. The computing device of Aspect 31, wherein the at least one processor is configured to: receive persistent user state associated with a user identifier from a persistent data store based on a request from the container, wherein the persistent user state comprises persistent data accumulated from previous containers; and update a local persistent state of the browser based on the persistent user state.

Aspect 33. The computing device of any of Aspects 31 to 32, wherein the at least one processor is configured to: identify synthetic input events in the control stream corresponding to inputs from human input devices, wherein the user stream identifies the synthetic input events provided to the browser.

Aspect 34. The computing device of Aspect 33, wherein the at least one processor is configured to: receive an inner monologue from the generative response engine, wherein the user stream includes a summary of the inner monologue.

Aspect 35. The computing device of any of Aspects 31 to 34, wherein the at least one processor is configured to: receive a first input to assert control of the browser from the remote client, wherein the agent is configured to pause transmission of the feedback stream when the remote client asserts control; and provide an instruction to the generative response engine to pause inference.

Aspect 36. The computing device of Aspect 35, wherein the at least one processor is configured to: based on receiving a second input from the remote client, provide the second input to the browser, wherein the user stream includes at least two images illustrating the execution of the browser based on the second input.

Aspect 37. The computing device of Aspect 36, wherein the at least one processor is configured to: receive a third input to relinquish control of the browser at the remote client; transmit the at least two images to the generative response engine with an instruction to resume inference based on changes between the at least two images; and resume transmission of the feedback stream to the generative response engine.

Aspect 38. The computing device of any of Aspects 31 to 37, wherein the at least one processor is configured to: based on receiving a request for human input from the generative response engine, transmit a human input request to the remote client; receive a response to the human input request from the remote client; provide an input to the browser based on the response including an instruction corresponding to a human input device in the browser; and provide a response to the generative response engine based on the response including information requested in the human input request.

Aspect 39. The computing device of Aspect 38, wherein the at least one processor is configured to: if the browser generates persistent state information to update a local persistent state of the browser based on the response, provide the persistent state information to a persistent data store.

Aspect 40. A non-transitory computer-readable medium having stored thereon instructions that, when executed by at least one processor, cause the at least one processor to perform operations according to any of Aspects 21 to 29.

Aspect 41. An apparatus for performing a function, comprising one or more means for performing operations according to any of Aspects 21 to 29.

1. A method, comprising:
transmitting, from a local application, an instruction to spawn a headless remote browser in a container executing on a remote browser service, wherein the instruction includes a task for the headless remote browser to perform at a first address;
receiving, by the local application, a stream based on execution of the task in the headless remote browser by a generative response engine, wherein the stream includes images illustrating the headless remote browser and data describing at least events generated by the generative response engine for the headless remote browser;
rendering the images and the data from the stream in the local application;
receiving a first input to assert control of the headless remote browser at the local application;
transmitting an instruction to control the headless remote browser from the local application based on the first input;
receiving a second input associated with a first image representing a current state of the headless remote browser at the local application;
transmitting information describing the second input to the headless remote browser; and
receiving a second image illustrating the headless remote browser based on a response to the second input.

2. The method of claim 1, further comprising:
selecting contextual information associated with a web address based on an input into the local application, wherein the contextual information comprises parameters in natural language input obtained from and user associated with at least one activity associated with the web address; and
transmitting a natural language task associated with the web address with the contextual information to the web address.

3. The method of claim 1, wherein the data comprises user interface events provided by the generative response engine and an inner monologue, wherein the inner monologue comprises a natural language explanation of an action taken by the generative response engine based on a corresponding input by the generative response engine.

4. The method of claim 3, further comprising:
displaying the user interface events and the inner monologue in a sequential list, wherein at least a current sub-task described by the inner monologue includes inputs for controlling the current sub-task.

5-6. (canceled)

7. The method of claim 1, further comprising:
receiving a third input to relinquish control of the headless remote browser at the local application; and
transmitting an instruction to the headless remote browser to relinquish control of the headless remote browser at the local application.

8. The method of claim 1, further comprising:
transmitting an instruction to the remote browser service to spawn a second headless remote browser in a second container, wherein the instruction includes a second natural language task for the second headless remote browser to perform at a second address, wherein the second container receives a persistent state information created at the headless remote browser.

9. The method of claim 1, further comprising:
identifying a human input request in the stream based on completion of a sub-task of a natural language task, wherein the human input request indicates the generative response engine has relinquished control of the headless remote browser;
based on an input responsive to the human input request, transmitting information to the headless remote browser corresponding to the input, wherein the generative response engine asserts control in response to the input.

10. A method of a control service configured to execute in a container, comprising:
receiving, at an agent associated with a container, an instruction to execute a natural language task at a web address using a headless remote browser executing within the container executing on a remote browser service;
transmitting, by the agent, a feedback stream to a generative response engine to illustrate the execution of the natural language task at the headless remote browser;
receiving, by the agent, a control stream from the generative response engine on a first interface to execute the natural language task at the headless remote browser;
providing, by the agent, instructions in the control stream to the headless remote browser; and
transmitting a user stream to a remote client for rendering the user stream to illustrate and describe execution of the natural language task at the headless remote browser;
receiving a first input to assert control of the headless remote browser from the remote client, wherein the agent is configured to pause transmission of the feedback stream when the remote client asserts control;
providing an instruction to the generative response engine to pause inference; and
based on receiving a second input from the remote client, providing the second input to the headless remote browser, wherein the user stream includes at least two images illustrating the execution of the headless remote browser based on the second input.

11. The method of claim 10, further comprising:
receiving persistent user state associated with a user identifier from a persistent data store based on a request from the container, wherein the persistent user state comprises persistent data accumulated from previous containers; and
updating a local persistent state of the headless remote browser based on the persistent user state.

12. The method of claim 10, further comprising:
identifying synthetic input events in the control stream corresponding to inputs from human input devices, wherein the user stream identifies the synthetic input events provided to the headless remote browser.

13. The method of claim 12, further comprising:
receiving an inner monologue from the generative response engine, wherein the user stream includes a summary of the inner monologue.

14-15. (canceled)

16. The method of claim 10, further comprising:
receiving a third input to relinquish control of the headless remote browser at the remote client;
transmitting the at least two images to the generative response engine with an instruction to resume inference based on changes between the at least two images; and
resuming transmission of the feedback stream to the generative response engine.

17. The method of claim 10, further comprising:
based on receiving a request for human input from the generative response engine, transmitting a human input request to the remote client;
receiving a response to the human input request from the remote client;
providing an input to the headless remote browser based on the response including an instruction corresponding to a human input device in the headless remote browser; and
providing a response to the generative response engine based on the response including information requested in the human input request.

18. The method of claim 17, further comprising:
if the headless remote browser generates persistent state information to update a local persistent state of the headless remote browser based on the response, providing the persistent state information to a persistent data store.

19. A computing device, comprising:
at least one memory; and
at least one processor coupled to the at least one memory and configured to:
transmit an instruction to spawn a headless remote browser in a container executing on a remote browser service, wherein the instruction includes a task for the headless remote browser to perform at a first address;
receive a stream based on execution of the task in the headless remote browser by a generative response engine, wherein the stream includes images illustrating the headless remote browser and data describing at least events generated by the generative response engine for the headless remote browser;
render the images and the data from the stream in a local application;
receive a first input to assert control of the headless remote browser at the local application;
transmit an instruction to control the headless remote browser from the local application based on the first input;
receive a second input associated with a first image representing a current state of the headless remote browser at the local application;
transmit information describing the second input to the headless remote browser; and
receive a second image illustrating the headless remote browser based on a response to the second input.
